(19) United States
(12) Patent Application Publication
(10) Pub. No.: US 2013/0230481 A1
(43) Pub. Date: Sep. 5, 2013

(54) WATER DISPERSION TYPE SUSTAINED RELEASE PREPARATION FOR RELEASING VOLATILE ACTIVE SUBSTANCE

(71) Applicant: NISSIN CHEMICAL INDUSTRY CO., LTD., Echizen-shi (JP)

(72) Inventors: Ryuichi Saguchi, Joetsu-shi (JP); Takehiko Fukumoto, Joetsu-shi (JP); Masahiko Ikka, Echizen-shi (JP); Kouji Kinoshita, Echizen-shi (JP); Hiroyuki Saitou, Echizen-shi (JP); Yoshihiro Ozawa, Echizen-shi (JP)

(73) Assignee: Nissin Chemical Industry Co., Ltd., Echizen-shi (JP)

(21) Appl. No.: 13/866,406

(22) Filed: Apr. 19, 2013

Related U.S. Application Data
(63) Continuation of application No. PCT/JP2012/078879, filed on Nov. 7, 2012.

(30) Foreign Application Priority Data
Nov. 7, 2011 (JP) 2011-243666

(51) Int. Cl. A01N 25/04

(52) U.S. Cl. CPC A01N 25/04
USPC 424/84; 524/391; 524/503; 524/354; 514/86; 512/26

(57) ABSTRACT

There is provided a water dispersion for a sustained release preparation, the dispersion having viscosity at 25° C. of not more than 100 mPa·s and including polymer particles which are obtained by polymerizing ethylenically unsaturated group-containing monomers (A), polyvinyl alcohol (C2) in an amount of more than 0% by weight but not more than 50% by weight relative to a total amount of the ethylenically unsaturated group-containing monomers (A), having a degree of saponification of more than 91.5 mol % and less than 98 mol %, and water. There is also provided a sustained release preparation including the water dispersion and a volatile active substance which is selected from a group consisting of a pheromone substance, an agricultural chemical, an aromatic, a deodorant and an antibacterial agent.

### RELATED APPLICATIONS

This application is a continuation of PCT/JP2012/078879, filed on Nov. 7, 2012, which claims priority from Japanese Application No. 2011-243666, filed on Nov. 7, 2011, the contents of which are incorporated herein by reference in their entireties.

### BACKGROUND OF THE INVENTION

The present invention relates to a water dispersion type sustained release preparation for releasing a volatile active substance. More specifically, the present invention relates to a water dispersion type sustained release preparation for releasing a volatile active substance, the preparation having low viscosity and a sufficient adhesion property suitable for an aerial spray from an aircraft or a helicopter or a ground spray from a vehicle such as a tractor, comprising a volatile active substance and a polymer water dispersion, and continuously releasing the volatile active substance at a constant rate over a long period of time after the spray.

### FIELD OF THE INVENTION

A sex pheromone has been utilized as a method for attracting or disrupting agricultural pests. For example, when the sex pheromone is applied to farmland, agricultural pests are attracted and collected by the sex pheromone. Because a mating ability for sensing or positioning the opposite sex is disrupted, procreation by mating is suppressed. The uniform release is generally attempted by using a sustained release preparation. It is necessary to uniformly release the sex pheromone for a period of not less than six weeks since a mating period of agricultural pests continues over the period. In addition, if the sex pheromone easily drops out owing to rain or wind, the sex pheromone is not uniformly released and the effect is not exhibited.

In the development of sustained release preparations, a sustained release preparation obtained by micro-capsuling a sex pheromone with a cellulose derivative (JP 58-183601A), sustained release preparations obtained by impregnating sex-pheromone-compatible synthetic resin pellets with a sex pheromone substance, pulverizing the pellets, and further coating the surfaces of the pulverized pellets with inorganic powder or granules or a synthetic resin which is not compatible with the pheromone substance (JP 61-92024A), a sustained release preparation obtained by mixing a synthetic resin pellet containing a sex pheromone substance with O/W type acrylic adhesive emulsion and suspending (JP 7-231743A) and the like have been disclosed. In addition, synthetic resin emulsion obtained from a polymerizable monomer having a specific functional group and one or more selected from unsaturated monocarboxylate ester, unsaturated dicarboxylate diester and aliphatic vinyl has been disclosed (JP 60-252403A and JP 61-5001A).

Furthermore, an attempt to solve the above problem by a micro-capsule technology utilizing polymer particles has been made in recent years. For example, a water dispersion type sustained release preparation characterized by comprising a sex pheromone in a micro gel made of a monomer component comprising a (meth)acrylate ester monomer and a multifunctional (meth)acrylate ester monomer is disclosed in JP 2001-158843A. A water dispersion type sustained release preparation having a sex pheromone release inhibitor further mixed is disclosed in JP 2004-331625A. Furthermore, micro-capsuling of a sex pheromone by multi-stage emulsion polymerization is disclosed in JP 2006-35210A. However, the aforementioned problem, particularly the problem of uniformly releasing substantially all of the comprised sex pheromone has not been fully solved in any of the above examples, and also, complicated steps such as pulverization, micro-capsuling and multi-stage polymerization have been required.

In addition, the above-mentioned studies on materials other than the sex pheromone have been conducted. For example, an application of a complex resin of polyurethane and vinyl polymer as a repellent, an antibacterial fungicide and an aromatic is disclosed in JP 2005-290034A. An application of a biodegradable resin including random or block copolyester for fragrance is disclosed in JP 11-106629A. However, the aforementioned problem has not necessarily been solved. Furthermore, a sustained release functional agent in which a functional material and a hydrophobic substance are embedded in a kneaded state in pores of a hydrophilic porous body having many pores which are open in the surface thereof and having a specific surface area of not less than 0.1 m²/g is disclosed in JP 10-17846A. A porous hollow polymer particle having a plurality of cavities therein is disclosed in JP 2009-120806A. However, the aforementioned problem has not been fully solved in any of the above examples, and complicated steps have been required.

### SUMMARY OF THE INVENTION

The present invention has been made in order to solve the problems in the related art, and provides a water dispersion type sustained release preparation for releasing a volatile active substance at a constant rate over a long period of time until substantially all the content of which can be released and which has low viscosity and a sufficient adhesion property.

As a result of an intensive study for achieving the above object, the present inventors have discovered that it is possible to release all the contents of the water dispersion type sustained release preparation for releasing a volatile active substance at a constant rate over a long period of time as described below, and that the preparation has low viscosity and a sufficient adhesion property, and have completed the present invention.

According to the present invention, there is provided a water dispersion for a sustained release preparation, the dispersion having viscosity at 25° C. of not more than 100 mPa·s, and comprising polymer particles which are obtained by polymerizing ethylenically unsaturated group-containing monomers (A), polyvinyl alcohol (C2) in an amount of more than 0% by weight but not more than 50% by weight relative to a total amount of the ethylenically unsaturated group-containing monomers (A), having a degree of saponification of more than 91.5 mol % and less than 98 mol %, and water.

In addition, according to the present invention, there is provided a sustained release preparation, comprising the water dispersion and a volatile active substance selected from a group consisting of a pheromone substance, an agricultural chemical, aromatic, a deodorant and an antibacterial agent.

Furthermore, according to the present invention, there is provided a method for producing a water dispersion for a sustained release preparation, comprising a polymerization step of emulsion-polymerizing ethylenically unsaturated group-containing monomers (A) in the presence of polyvinyl alcohol to obtain a polymer particle water dispersion having viscosity at 25° C. of not more than 100 mPa·s, wherein the polyvinyl alcohol is selected from a group consisting of polyvinyl alcohol (C2) having a degree of saponification of more than 91.5 mol % and less than 98 mol %, a combination of the polyvinyl alcohol (C2) and polyvinyl alcohol (C3) having a degree of saponification of not less than 98 mol %, and a combination of the polyvinyl alcohols (C2) and (C3) and polyvinyl alcohol (C1) having a degree of saponification of more than 82 mol % but not more than 91.5 mol %; and when the polyvinyl alcohol is the polyvinyl alcohol (C2) in absence of the polyvinyl alcohols (C1) and (C3), the polyvinyl alcohol (C2) in an amount of more than 0% by weight but not more than 50% by weight relative to a total amount of the ethylenically unsaturated group-containing monomers (A) is present during the polymerization; when the polyvinyl alcohol is the combination of the polyvinyl alcohols (C2) and (C3) in absence of the polyvinyl alcohol (C1), all of the polyvinyl alcohols (2) and (3) are present during the polymerization, or one of the polyvinyl alcohols (C2) and (C3) is present during polymerization and the other of the polyvinyl alcohols (C2) and (C3) is blended after the polymerization, so that a total amount of the polyvinyl alcohols (2) and (3) is more than 0% by weight buy not more than 50% by weight relative to the total amount of the ethylenically unsaturated group-containing monomers (A) and; when the polyvinyl alcohol is the combination of the polyvinyl alcohols (C2), (C3) and (C1), all of the polyvinyl alcohols (C2), (C3) and (C1) are present during the polymerization, or one or two types of the polyvinyl alcohols (C2), (C3) and (C1) are present during the polymerization and the other type or types of the polyvinyl alcohols (C2), (C3) and (C1), which are not present during the polymerization, are blended after the polymerization, so that a total amount of the polyvinyl alcohols (C2), (C3) and (C1) is more than 0% by weight but not more than 50% by weight relative to the total amount of the ethylenically unsaturated group-containing monomers (A).

According to the present invention, provided is a water dispersion type sustained release preparation for releasing a volatile active substance at a constant rate over a long period of time until substantially all the content of which can be released and which has low viscosity and a sufficient adhesion property.

### BRIEF DESCRIPTION OF DRAWINGS

FIG. 1 is a graph exhibiting a relationship between remaining amounts of pheromone and elapsed days in Examples 1 to 9 and Comparative Example 1.

FIG. 2 is a graph exhibiting a relationship between remaining amounts of pheromone and elapsed days in Examples 10 to 20.

FIG. 3 is a graph exhibiting a relationship between remaining amounts of pheromone and elapsed days in Examples 21 to 26.

FIG. 4 is a graph exhibiting a relationship between remaining amounts of pheromone and elapsed days in Examples 27, 29, 31, 33 and 40.

FIG. 5 is a graph exhibiting a relationship between remaining amounts of pheromone and elapsed days in Examples 49 to 54.

FIG. 6 is a graph exhibiting a relationship between remaining amounts of pheromone and elapsed days in Examples 55 to 59.

FIG. 7 is a graph exhibiting a relationship between remaining amounts of pheromone and elapsed days in Examples 60 to 65.

FIG. 8 is a graph exhibiting a relationship between remaining amounts of pheromone and elapsed days in Examples 66 to 70.

FIG. 9 is a graph exhibiting a relationship between remaining amounts of pheromone and elapsed days in Examples 71 to 76.

FIG. 10 is a graph exhibiting a relationship between remaining amounts of pheromone and elapsed days in Examples 77 to 81.

FIG. 11 is a graph exhibiting a relationship between remaining amounts of pheromone and elapsed days in Examples 82 to 87.

### DESCRIPTION OF THE EMBODIMENTS OF THE INVENTION

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. Unless otherwise defined, all technical and scientific terms used herein have the same meaning as commonly understood by one of ordinary skill in the art to which this invention belongs. All references cited are incorporated herein by reference in their entirety.

It should also be understood that many modifications and variations of the described embodiments of the invention will occur to a person having an ordinary skill in the art without departing from the spirit and scope of the present invention as claimed in the appended claims.

Examples of the ethylenically unsaturated group-containing monomers (A) to be used in the present invention include olefin hydrocarbon monomers such as ethylene and propylene; vinyl carboxylate monomers such as vinyl acetate and vinyl propionate; chlorine-containing ethylene monomers such as vinyl chloride and vinylidene chloride; aromatic vinyl monomers such as styrene and α-methylstyrene; conjugated diene monomers such as 1,3-butadiene and 2-methyl-1,3-butadiene; ethylenically unsaturated monocarboxylate ester monomers such as methyl acrylate, ethyl acrylate, butyl acrylate, 2-ethylhexyl acrylate and methyl methacrylate; ethylenically unsaturated dicarboxylate ester monomers such as dimethyl itaconate, diethyl maleate, monobutyl maleate, monoethyl fumarate and dibutyl fumarate; ethylenically unsaturated monocarboxylic acid monomers such as acrylic acid, methacrylic acid and crotonic acid; and ethylenically unsaturated dicarboxylic acid monomers such as itaconic acid, maleic acid and fumaric acid; epoxy group-containing ethylenically unsaturated monocarboxylate ester monomers such as glycidyl methacrylate; alcohol group-containing ethylenically unsaturated monocarboxylate ester monomers such as 2-hydroxyethyl methacrylate; alkoxyl group-containing ethylenically unsaturated monocarboxylate ester monomers such as methoxyethyl acrylate; nitrile group-containing ethylene monomers such as acrylonitrile; amide group-containing ethylene monomers such as acrylamide; amino group-containing ethylenically unsaturated monocarboxylate ester monomers such as dimethylaminoethyl methacrylate; and monomers containing two or more ethylenically unsaturated groups in one molecule such as divinylbenzene and allyl methacrylate. The vinyl carboxylate monomers and ethylenically unsaturated monocarboxylate ester are preferable.

The number of carbon atoms in the ethylenically unsaturated group-containing monomers (A) preferably ranges from 2 to 13 including the number of carbon atoms in the functional group.

In addition, a glass-transition temperature T of the polymer particles obtained by polymerizing the ethylenically unsaturated group-containing monomers (A) (hereinafter, the glass-transition temperature may be referred to as Tg) is preferably not more than 30° C., more preferably from −50° C. to 30° C. in consideration of a point that the applied sustained release preparation is adhered to leaves and does not fall to the ground. The monomer is selected using the following equation.

(Pa+Pb+Pc)/T=(Pa/Ta)+(Pb/Tb)+(Pc/Tc) (1)

In Equation (1), T represents a glass-transition temperature (K) of the polymer particles, Pa, Pb and Pc represent contents (% by weight) of the monomers a, b and c, respectively, and Ta, Tb, and Tc represent homopolymer glass-transition temperatures (K) of the monomer a, b, and c, respectively.

The glass-transition temperature can be measured based on JIS K 7121.

According to the present invention, at least one kind of polyvinyl alcohol (hereinafter, referred to as “PVA” in some cases) is present in a system. The ethylenically unsaturated group-containing monomers (A) may be polymerized in the presence of the one or more kinds of PVAs, or may be polymerized in the presence of one part of the one or more kinds of PVAs and the other part (e.g., the other kinds) of the one or more kinds of PVAs may be added to the obtained polymer particle water dispersion after the polymerization. If PVA is not used, only a part of the volatile active substance is released, and the release rate cannot be controlled.

Specifically, the water dispersion for a release preparation may be obtained by polymerizing the ethylenically unsaturated group-containing monomers (A) in the presence of polyvinyl alcohol selected from a group consisting of polyvinyl alcohol (C2) having a degree of saponification of more than 91.5 mol % and less than 98 mol %, a combination of polyvinyl alcohol (C2) and polyvinyl alcohol (C3) having a degree of saponification of not less than 98 mol %, and a combination of polyvinyl alcohols (C2) and (C3) and polyvinyl alcohol (C1) having a degree of saponification of more than 82 mol % but not more than 91.5 mol %. When the polyvinyl alcohol is polyvinyl alcohol (C2) in absence of polyvinyl alcohols (C3) and (C1), all of the polyvinyl alcohol (C2) is present during the polymerization, or one part of the polyvinyl alcohol (C2) is present during the polymerization and the other part of the polyvinyl alcohol is blended after the polymerization, so that an amount of the polyvinyl alcohol (2) is more than 0% by weight but not more than 50% by weight relative to the total amount of the ethylenically unsaturated group-containing monomers (A). When the polyvinyl alcohol is a combination of polyvinyl alcohols (C2) and (C3) in the absence of polyvinyl alcohol (C1), all of the polyvinyl alcohols (C2) and (C3) are present during the polymerization, or one part of the polyvinyl alcohols (C2) and (C3) is present during the polymerization and the other part of the polyvinyl alcohols (C2) and (C3) is blended after the polymerization, so that a total amount of the polyvinyl alcohols (C2) and (C3) is more than 0% by weight but not more than 50% by weight relative to the total amount of the ethylenically unsaturated group-containing monomers (A). When the polyvinyl alcohol is a combination of polyvinyl alcohols (C1), (C2) and (C3), all of the polyvinyl alcohols (C1), (C2) and (C3) are present during the polymerization, or one part of the polyvinyl alcohols (C1), (C2) and (C3) is present during the polymerization and the other part of the polyvinyl alcohols (C1), (C2) and (C3) is blended after the polymerization, so that the total amount of the polyvinyl alcohols (C1), (C2) and (C3) is more than 0% by weight but not more than 50% by weight relative to the total amount of the ethylenically unsaturated group-containing monomers (A).

In a preferable embodiment, polyvinyl alcohol (C2) can be used in the absence of polyvinyl alcohols (C3) and (C1), and the polyvinyl alcohol (C2) can be present during the polymerization in an amount of more than 0% by weight but not more than 50% by weight relative to the total amount of the ethylenically unsaturated group-containing monomers (A) without the blending after the polymerization.

In another preferable embodiment, polyvinyl alcohols (C2) and (C3) can be used in the absence of polyvinyl alcohol (C1), and the polyvinyl alcohols (C2) and (C3) can be present during the polymerization without the blending after the polymerization, or the polyvinyl alcohol (C2) can be present during the polymerization and the polyvinyl alcohol (C3) can be blended after the polymerization, or the polyvinyl alcohol (C3) can be present during the polymerization and the polyvinyl alcohol (C2) can be blended after the polymerization, so that the total amount of the polyvinyl alcohols (C2) and (C3) is more than 0% by weight but not more than 50% by weight relative to the total amount of the ethylenically unsaturated group-containing monomers (A).

In a still another preferable embodiment, polyvinyl alcohols (C1), (C2) and (C3) can be used, and the polyvinyl alcohol (C1), (C2) and (C3) can be present during the polymerization without the blending after the polymerization, or the polyvinyl alcohol (C1) can be present during the polymerization and the polyvinyl alcohols (C2) and (C3) can be blended after the polymerization, or the polyvinyl alcohol (C2) can be present during the polymerization and the polyvinyl alcohols (C1) and (C3) can be blended after the polymerization, or the polyvinyl alcohol (C3) can be present during the polymerization and the polyvinyl alcohols (C1) and (C2) can be blended after the polymerization, or the polyvinyl alcohols (C1) and (C2) can be present during the polymerization and the polyvinyl alcohol (C3) can be blended after the polymerization, or the polyvinyl alcohols (C1) and (C3) can be present during the polymerization and the polyvinyl alcohol (C2) can be blended after the polymerization, or the polyvinyl alcohols (C2) and (C3) can be present during the polymerization and the polyvinyl alcohol (C1) can be blended after the polymerization.

The degree of saponification of PVA to be used in the present invention is preferably more than 82 mol %. When the degree of saponification is not more than 82 mol %, the amount of remaining acetate in PVA is large so that compatibility with the volatile active substance becomes higher. As a result, there may be defect that a desired release rate cannot be achieved, or defect that some of the volatile active substance is not released and is wasted. In addition, although a degree of polymerization of PVA is not particularly limited, an aqueous solution of PVA having a high degree of polymerization may have high viscosity and it may become necessary to reduce an evaporation residue in order to obtain proper viscosity of the polymer particle water dispersion. In order to reduce the evaporation residue, the volatile active substance for impregnation is decreased. Accordingly, an average degree of polymerization calculated based on JIS K 6726 is preferably from 400 to 2000, more preferably from 500 to 1700.

Since it is considered that the polymer part inside the emulsion particle is more hydrophobic than an external dispersant so that it is considered that the inside of the emulsion particle is impregnated with the hydrophobic volatile active substance.

Examples of the polymerization initiator to be used in the present invention include persulfate salts such as sodium persulfate, ammonium persulfate and potassium persulfate; azo compounds such as 2,2′-diamidino-2,2′-azopropane dihydrochloride and azobisisobutyronitrile; peroxide such as cumene hydroperoxide, benzoyl peroxide and hydrogen peroxide. In addition, a known redox initiator such as potassium persulfate and sodium hydrogen sulfite can also be exemplified. The amount of the polymerization initiator is typically from 0.05 to 10% by weight, preferably from 0.1 to 2% by weight relative to the total amount of the monomers.

According to the present invention, the temperature at which the polymer particle water dispersion is produced is generally 30° C. to 95° C., preferably 60° C. to 80° C., and the polymerization time is generally 3 to 20 hours, preferably 4 to 8 hours. The polymerization is carried out preferably in an atmosphere of inert gas such as nitrogen gas.

The weight-average molecular weight of the polymer produced by polymerization of the ethylenically unsaturated group-containing monomers (A) is preferably from 100,000 to 1 million, more preferably from 100,000 to 800,000 in terms of polystyrene measured by using gel permeation chromatography (GPC).

The solid content of the polymer particle water dispersion is preferably from about 30 to 65% by weight.

In addition, an ethylenically unsaturated group-containing monomer having a functional group can be comprised in an amount which does not compromise the effect of the present invention. Such examples include epoxy group-containing monomers such as glycidyl methacrylate; methylol group-containing monomers such as N-methylolacrylamide; alcoholic hydroxyl group-containing monomers such as 2-hydroxyethyl methacrylate; alkoxyl group-containing monomers such as methoxyethyl acrylate; nitrile group-containing monomers such as acrylonitrile; amide group-containing monomers such as acrylamide; amino group-containing monomers such as dimethylaminoethyl methacrylate; and monomers having two or more ethylenically unsaturated groups in one molecule such as divinylbenzene and allyl methacrylate.

As for the polymerization in the present invention, any known polymerization methods such as emulsion-polymerization method can be employed. The monomer and a polymerization aid may be added all at once in an initial stage, or may be continuously added, or one part of the monomer and the polymerization aid may be added in an initial stage and the other part thereof may be continuously or dividedly added during the polymerization. The polymerization aid includes an emulsifier such as alkyl sulfuric acid ester salt, a polymerization initiator such as ammonium persulfate, a chain transfer agent such as mercaptans, a pH adjuster such as sodium carbonate, and various kinds of defoaming agent.

According to the present invention, in a first embodiment of the water dispersion type sustained release preparation, the water dispersion type sustained release preparation comprises a polymer particle water dispersion which is obtained by polymerizing the ethylenically unsaturated group-containing monomers (A) and which comprises the polyvinyl alcohol (C2) having a degree of saponification of more than 91.5 mol % and less than 98 mol %.

The polyvinyl alcohol (C2) having a degree of saponification of more than 91.5 mol % and less than 98 mol % is used in an amount of more than 0% by weight but not more than 50% by weight, preferably from 5 to 25% by weight relative to the total amount of the ethylenically unsaturated group-containing monomers (A). When the amount exceeds 50% by weight, there is defect that the polymer particle water dispersion becomes hydrophilic and after the polymer particle water dispersion is applied to a target and changed to a dried film, the film is re-emulsified by a small amount of rain or the like, and the volatile active substance falls off along with the polymer particles.

According to the present invention, in a second embodiment of the water dispersion type sustained release preparation, the water dispersion type sustained release preparation comprises a polymerization particle water dispersion which is obtained by polymerizing the ethylenically unsaturated group-containing monomers (A) and which comprises the polyvinyl alcohol (C2) having a degree of saponification of more than 91.5 mol % and less than 98 mol % and the polyvinyl alcohol (C3) having a degree of saponification of not less than 98 mol %.

When the polyvinyl alcohol (C2) having a degree of saponification of more than 91.5 mol % and less than 98 mol % and the polyvinyl alcohol (C3) having a degree of saponification of not less than 98 mol % are used, each of them is used in an amount of more than 0% by weight and less than 50% by weight, preferably more than 0% by weight but not more than 30% by weight, further more preferably from 5 to 25% by weight relative to the total amount of the ethylenically unsaturated group-containing monomers (A). When the amount exceeds 50% by weight, there may be defect that the polymer particle water dispersion becomes hydrophilic and after the polymer particle water dispersion is applied to a target and changed to a dried film, the film is re-emulsified by a small amount of rain or the like, and the volatile active substance falls off along with the polymer particles.

Furthermore, because of the same reason, the total amount of the polyvinyl alcohols (C2) and (C3) is more than 0% by weight but not more than 50% by weight, preferably from 5 to 25% by weight relative to the total amount of the ethylenically unsaturated group-containing monomers (A).

According to the present invention, in a third embodiment of the water dispersion type sustained release preparation, the water dispersion type sustained release preparation comprises a polymer particle water dispersion which is obtained by polymerizing the ethylenically unsaturated group-containing monomers (A) and which comprises polyvinyl alcohol (C1) having a degree of saponification of more than 82 mol % but not more than 91.5 mol %, polyvinyl alcohol (C2) having a degree of saponification of more than 91.5 mol % and less than 98 mol % and polyvinyl alcohol (C3) having a degree of saponification of not less than 98 mol %.

When the polyvinyl alcohol (C1) having a degree of saponification of more than 82 mol % but not more than 91.5 mol %, the polyvinyl alcohol (C2) having a degree of saponification of more than 91.5 mol % and less than 98 mol %, and the polyvinyl alcohol (C3) having a degree of saponification of not less than 98 mol % are used, each of them is used in an amount of more than 0% by weight and less than 50% by weight, preferably more than 0% by weigh but not more than 30% by weight, more preferably from 5 to 25% by weight relative to the total amount of the ethylenically unsaturated group-containing monomers (A). When the amount exceeds 50% by weight, there may be defect that the polymer particle water dispersion becomes hydrophilic and after the polymer particle water dispersion is applied to a target and changed to a dried film, the film is re-emulsified by a small amount of rain or the like and the volatile active substance falls off along with the polymer particles.

Furthermore, because of the same reason, the total amount of the polyvinyl alcohols (C1), (C2) and (C3) is preferably not less than 0% by weight but not more than 50% by weight, more preferably from 5 to 25% by weight relative to the total amount of the ethylenically unsaturated group-containing monomers (A).

In addition, PVA having a special functional group such as an anion-modified PVA, a cation-modified PVA, and a terminally SH-modified PVA can also be used.

A molar ratio of hydrophilic part to acetate part will be explained. The molar ratio of hydrophilic part to acetate part is a ratio of a molar amount of hydrophilic part which is a total molar amount of vinyl alcohol monomer units to a molar amount of acetate part which is a total molar amount of vinyl acetate monomer units in the total amount of the polyvinyl alcohol.

When x parts by weight of polyvinyl alcohol (A) having a degree of saponification of 100α mol % and y parts by weight of polyvinyl alcohol (B) having a degree of saponification of 100β mol % are used, the following equations are obtained, provided that the molecular weight of the vinyl alcohol is 44, and the molecular weight of the vinyl acetate is 86.

Molar amount of hydrophilic part=x×44α/{44α+86(1−α)}/44+y×44β/{44β+86(1−β)}/44 (2)

Molar amount of acetate part=x×86(1−α)/{44α+86(1−α)}/86+y×86(1−β)/{44β+86(1−β)}/86 (3)

The molar ratio of hydrophilic part to acetate part is calculated by dividing a value obtained in equation (2) by a value obtained in equation (3).

When x parts by weight of polyvinyl alcohol (A) having a degree of saponification of 100α mol %, y parts by weight of polyvinyl alcohol (B) having a degree of saponification of 100β mol %, and z parts by weight of polyvinyl alcohol (C) having a degree of saponification of 100γ mol % are used, the following equations are obtained, provided that the molecular weight of the vinyl alcohol is 44, and the molecular weight of the vinyl acetate is 86.

$$\begin{matrix}Molar amount of hydrophilic part = x \times 44 α / \{ 44 α + 86 ( 1 - α ) \} / 44 + y \times 44 β / \{ 44 β + 86 ( 1 - β ) \} / 44 + z \times 44 γ / \{ 44 γ + 86 ( 1 - γ ) \} / 44 & ( 4 ) \\ Molar amount of acetate part = x \times 86 ( 1 - α ) / \{ 44 α + 86 ( 1 - α ) \} / 86 + y \times 86 ( 1 - β ) / \{ 44 β + 86 ( 1 - β ) \} / 86 + z \times 86 ( 1 - γ ) / \{ 44 γ + 86 ( 1 - γ ) \} / 86 & ( 5 )\end{matrix}$$

The molar ratio of hydrophilic part to acetate part is calculated by dividing a value obtained in equation (4) by a value obtained in equation (5). The molar ratio of hydrophilic part to acetate part is preferably not more than 40.0.

When the polyvinyl alcohol (C2) is used in the absence of the polyvinyl alcohols (C1) and (C3), the molar ratio of hydrophilic part to acetate part (molar ratio of hydrophilic part/acetate part) of the polyvinyl alcohol (C2) is preferably not more than 40.0, more preferably from 15.5 to 40.0. When the ratio exceeds 40.0, there may be defect that the release rate of the volatile active substance becomes excessively high.

When the polyvinyl alcohols (C2) and (C3) are used in the absence of the polyvinyl alcohol (C1), the molar ratio of hydrophilic part to acetate part (molar ratio of hydrophilic part/acetate part) of the polyvinyl alcohols (C2) and (C3) is preferably not more than 40.0, more preferably from 15.5 to 40.0. When the ratio exceeds 40.0, there may be defect that the release rate of the volatile active substance becomes excessively high.

When the polyvinyl alcohols (C1), (C2) and (C3) are used, the molar ratio of hydrophilic part to acetate part (molar ratio of hydrophilic part/acetate part) of the polyvinyl alcohols (C1), (C2) and (C3) is preferably not more than 40.0, more preferably from 15.5 to 40.0. When the ratio exceeds 40.0, there may be defect that the release rate of the volatile active substance becomes excessively high.

The volatile active substance to be used in the present invention is not particularly limited. Preferable examples thereof include a pheromone substance, an agricultural chemical, an aromatic, a deodorant and an antibacterial agent. When the compatibility between a volatile active substance and PVA becomes excessively high, the volatile active substance may be unreleased and remain. Accordingly, a volatile active substance is preferably selected from a group consisting of acetate, alcohol (including phenol), epoxide, alkane, alkene, aldehyde, ketone, carboxylic acid, ester and ether, each having a boiling point (normal boiling point at 1 atm) of from 100° C. to 350° C. and having 6 to 20 carbon atoms. It is further preferable to select a compound having a boiling point of from 200° C. to 350° C. with respect to a pheromone substance and a compound having a boiling point of from 100° C. to 320° C. with respect to the volatile active substances other than the pheromone substance.

Examples of the pheromone substance for fruit tree pests include Z-8-dodecenyl acetate as sex pheromone of Oriental Fruit Moth (OFM), E,E-8,10-dodecadienol as sex pheromone of Codling Moth (CDM), and E-5-decenyl acetate as sex pheromone of Peach Twig Borer (PTwB). Examples of pheromone substance for forest pests include (±)-cis-7,8-epoxy-2-methyloctadecane as sex pheromone of Gypsy Moth (GM). Examples of sex pheromone for cotton pests include ZZ/ZE-7,11-hexadecadienyl acetate as sex pheromone of Pink Bollworm (PBW).

Examples of the agricultural chemical include an agricultural chemical having a relatively high vapor pressure such as diazinon and propylene glycol fatty acid monoester.

Examples of the aromatic include natural essential oils such as orange oil, lemon oil and lemongrass oil; hydrocarbon terpenes such as α-pinene, β-pinene and limonene; aldehydes such as heptanal, octanal and citral; ester such as ethyl formate and methyl acetate; lactonic acid; ethers such as anisole and p-cresyl methyl ether; alcohols such as trans-2-hexenol and leaf alcohol; ketones such as menthone and acetophenone.

Examples of the deodorant include a botanical extract type deodorant such as lauryl methacrylate and polyphenol; and a reactive type deodorant such as betaine compound.

Examples of the antibacterial agent include aldehydes such as phenylpropionic aldehyde and citral; and alcohols such as linalool and citronellol.

The amount of the volatile active substance comprised by the water dispersion type sustained release preparation (content before use, or initial content) is preferably from 3 to 20% by weight, more preferably from 5 to 10% by weight relative to the total amount of the ethylenically unsaturated group-containing monomers (A). When the amount is less than 3% by weight, the release rate may become extremely low. When the amount is more than 20% by weight, the release rate may become excessively high. The amount of the volatile active substance desirably reaches less than 5% by weight at the end of use, provided that the initial amount (the amount when the release is started) is 100% by weight. As for the pheromone substance, the remaining amount of the volatile active substance preferably becomes 60 to 75% by weight after 10 days, not more than 35% by weight after 60 days, and less than 5% by weight after 70 days to 120 days, provided that the initial amount is 100% by weight. As for the volatile active substance other than the pheromone substance, the remaining amount of the volatile active substance preferably becomes 60 to 80% by weight after 20 days, not more than 35% by weight after 90 days, and less than 5% by weight after 120 days to 250 days, provided that the initial amount is 100% by weight.

Most types of volatile active substances are lipophilic and not dissolved in water. When the volatile active substance is mixed with polymer particle water dispersion, the polymer particle water dispersion is impregnated with the volatile active substance.

The volatile active substance is added after the polymerization of the ethylenically unsaturated group-containing monomers (A).

The water dispersion type sustained release preparation is obtained by mixing the polymer particle water dispersion and the volatile active substance by using a known mixing preparation method such as use of a propeller type stirrer. The temperature for mixing may be a temperature at which the volatile active substance is not evaporated. It is preferably from 10 to 30° C. The stirring time is preferably from 5 minutes to 2 hours.

The time at which the volatile active substance is mixed may be after the polymerization step or before blending the polyvinyl alcohol after the polymerization.

The viscosity of the sustained release preparation is preferably not more than 100 mPa·s, further preferably from 30 to 100 mPa·s. Since the addition of the volatile active substance has substantially no influence on the viscosity of the sustained release preparation, the viscosity of the polymer particle water dispersion is preferably not more than 100 mPa·s, further preferably from 30 to 100 mPa·s. When the viscosity exceeds 100 mPa·s, the particle size during the spray increases, which may not be preferable. The viscosity at 25° C. can be measured by using a B-type viscosity meter.

The sustained release preparation can be sprayed, for example, through an aerial spray from an aircraft or a helicopter, or through a ground spray from a vehicle such as a tractor. It is also possible to utilize a conventional method in which a container filled with the sustained release preparation is installed. The sustained release preparation can be sprayed at a constant amount, for example, through a spray or an atomizing nozzle.

In addition, it is also possible to use a base material such as cotton cloth, wood, paper and plastic, which has been coated or impregnated with the sustained release preparation.

The spray amount of the volatile active substance is preferably from 50 to 3000 g/acre. The sprayed or applied sustained release preparation is formed, through air drying or heat drying, into a membrane, a film or a particle preferably having a thickness of from 0.5 to 500 μm, more preferably 1 to 100 μM, although depending on a sprayed or applied amount. Then the volatile active substance is released at a constant rate.

Hereinafter, the present invention will be explained based on Examples and Comparative Examples. However, it should not be construed that the present invention is limited to Examples.

### EXAMPLES

### Example 1

The 70 parts by weight of ion-exchanged water was placed in a four-necked glass flask equipped with a stirrer, a reflux condenser and a thermometer, and air displacement with nitrogen was sufficiently performed in the flask. Then stirring was started. The temperature inside the flask was raised to 75° C., and 0.5 parts by weight of sodium persulfate was added thereto as a polymerization initiator.

The 100 parts by weight of vinyl acetate monomers, 150 parts by weight of aqueous 10 wt % (% by weight) solution of PVA (JM-17L produced by Japan VAM & POVAL Co., Ltd., a degree of saponification of 96 mol %, an average polymerization degree of 1700), which was 15% by weight relative to the vinyl acetate monomers, and 20 parts by weight of ion-exchanged water were placed and stirred in a homo-mixer for 5 minutes to prepare a emulsion of monomers. After the emulsion was added dropwise into the four-necked flask for 4 hours, the polymerization was further continued for 2 hours. Then, the resulting mixture was reacted at 80° C. for one hour and cooled to 30° C. A polyvinyl acetate particle water dispersion having 34.1% by weight of evaporation residue and viscosity of 60 mPa·s was obtained.

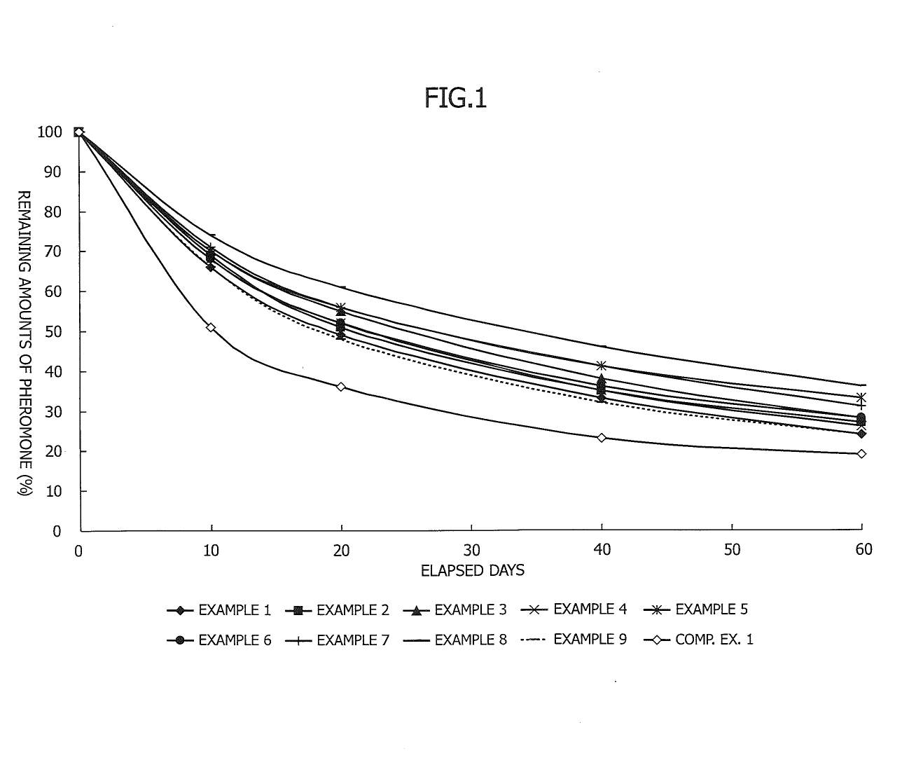

To the water dispersion, 5 parts by weight of Z-8-dodecenyl acetate (product of Shin-Etsu Chemical Co., Ltd., boiling point of 300° C.) as sex pheromone of OFM was added. The mixture was stirred at 25° C. for 1 hour to produce a sustained release preparation. Then, the molar ratio of hydrophilic part/acetate part was calculated in the manner shown below, the evaporation residue and the viscosity of the polymer particle water dispersion were measured, and a weather resistant test and a volatile active substance release test of the sustained release preparation were conducted. The composition in each step is shown in Table 1, and the results are shown in Table 2 and FIG. 1.

### <Calculation of a Molar Ratio of Hydrophilic Part to Acetate Part>

$$\begin{matrix}\begin{matrix} Molar amount of hydrophilic part = \frac{\frac{15 \times 44 \times 0.96}{\{ \begin{matrix}44 \times 0.96 + \\ 86 \times ( 1 - 0.96 )\end{matrix} \}}}{44} \\ = 0.3152\end{matrix} & \\ \begin{matrix} Molar amount of acetate part = \frac{\frac{15 \times 86 \times ( 1 - 0.96 )}{\{ \begin{matrix}44 \times 0.96 + \\ 86 \times ( 1 - 0.96 )\end{matrix} \}}}{86} \\ = 0.0131\end{matrix} & \\ Molar ratio of hydrophilic part to actate part = 0.3152 / 0.0131 = 24.1 & \end{matrix}$$

### <Evaporation Residue>

A sample of about 1 g of the polymer particle water dispersion was precisely measured and placed on a dish made of aluminum foil. The sample on the dish was placed in a drier which had been maintained at about 105° C., and heated for one hour. It was taken out from the drier, and cooled in a desiccator. The weight of the sample after the drying was measured, and the evaporation residue was calculated by the following equation.

$$R = \frac{T - L}{W - L} \times 100$$

R: evaporation residue (% by weight)
W: weight of aluminum foil dish with sample thereon before drying (g)
L: weight of aluminum foil dish (g)
T: weight of aluminum foil dish with sample thereon after drying (g)
Dimension of aluminum foil dish: 70φ×height 12 (mm)<

### <Viscosity Measuring Method by B-Type Viscosity Meter>

The liquid temperature of the polymer particle water dispersion was maintained at 25±1.0° C., and the viscosity was measured by a BM type viscosity meter (60 rpm).

### <Glass-Transition Temperature of Polymer>

The glass-transition temperature was measured based on JIS K 7121.

### <Weather Resistance>

Twelve dots of 2 μl of the obtained water dispersion type sustained release preparation containing the volatile active substance were marked on a glass plate and dried in a dryer at 25° C. for one day. The number of dots which fell off during watering from a watering pot for 10 minutes was checked.

High: all the twelve dots were held.
Low: falling off of at least one dot among the twelve dots was observed.

### <Volatile Active Substance Release Test>

The 2 μl dot of the obtained water dispersion type sustained release preparation containing the volatile active substance was applied to a film made of polyethylene terephthalate, dried in a constant temperature and constant moisture room at 23° C. and 45% RH for 16 hours, to obtain the dried sustained release preparation containing volatile active substance.

Next, the preparation was installed in a dryer with a wind velocity of 0.7 m/second, and changes in weight were measured as a release rate of the volatile active substance from the preparation. In addition, the temperature in the dryer was set to 25° C. when the sustained release preparations contained sex pheromone of OFM, or CDM or PTwB which will be described later. The temperature in the dryer was set to 30° C. when the sustained release preparation contained sex pheromone of GM or PB W, which will be described later, or the other kind of volatile active substance.

As the release amount of the volatile active substance, the remaining amounts of the volatile active substance on 10th day, 20th day, 30th day and 40th day, or 20th day, 40th day, 60th day and 90th day are shown by a weight ratio relative to the initial amount (the amount when the release was started) of 100. In addition, the days when the remaining amount of the volatile active substance reached not more than 5% (weight ratio of not more than 5) were shown in Tables.

### Examples 2 to 9 and Comparative Examples 1 and 2

The polymer particle water dispersion and the sustained release preparation were produced based on the polymerization compositions with an addition after the polymerization as shown in Table 1 in the same manner as in Example 1. Then the same tests as those in Example 1 were conducted. The used PVA included JM-17L (product of Japan VAM & POVAL Co., Ltd., a degree of saponification of 96 mol %, an average polymerization degree of 1700) and JT-05 (product of Japan VAM & POVAL Co., Ltd., a degree of saponification of 94 mol %, an average polymerization degree of 500). The used sex pheromone included Z-8-dodecenyl acetate (product of Shin-Etsu Chemical Co., Ltd., boiling point of 300° C.) as sex pheromone of OFM, E,E-8,10-dodecadienol (product of Shin-Etsu Chemical Co., Ltd., boiling point of 271° C.) as sex pheromone of CDM, (±)-cis-7,8-epoxy-2-methyloctadecane (product of Shin-Etsu Chemical Co., Ltd., boiling point of 332° C.) as sex pheromone of GM, E-5-dodecenyl acetate (product of Shin-Etsu Chemical Co., Ltd., boiling point of 211° C.) as sex pheromone of PTwB, and ZZ/ZE-7,11-hexadecadienyl acetate (product of Shin-Etsu Chemical Co., Ltd., boiling point of 349° C.) as sex pheromone of PBW. In Comparative Example 2, the sustained release preparation was produced in the same manner as in Example 1 except that PVA was not used and surfactant PERSOFT EL (product of NOF Corporation, anion surfactant of sodium polyoxyethylene laurylether sulfate, molecular weight of 420) was used. The results are shown in Table 2 and FIG. 1.

TABLE 1

| | polymerization step | | | | | | |
|---|---|---|---|---|---|---|---|
| | (part by weight) | | | | | after | |
| | monomer | | | polyvinyl | | polymerizaton | |
| | vinyl | ethyl | butyl | alcohol | | (part by weight) | |
| | acetate | acrylate | acrylate | (C2) *1 | surfactant | pheromone | |
| Example 1 | 100 | — | — | 15(M) | — | OFM | 5 |
| Example 2 | 50 | — | 50 | 8(T) | — | OFM | 5 |
| Example 3 | — | 20 | 80 | 10(M) | — | OFM | 5 |
| Example 4 | 100 | — | — | 15(M) | — | CDM | 5 |
| Example 5 | 100 | — | — | 15(M) | — | GM | 5 |
| Example 6 | 100 | — | — | 15(M) | — | PTwB | 5 |
| Example 7 | 100 | — | — | 15(M) | — | PBW | 5 |
| Example 8 | 100 | — | — | 15(M) | — | OFM | 3.5 |
| Example 9 | 100 | — | — | 15(M) | — | OFM | 10 |
| Comp. Ex. 1 | 100 | — | — | 53(M) | — | OFM | 5 |
| Comp. Ex. 2 | 100 | — | — | — | 5(PERSOFTEL) | OFM | 5 |

*1 As the polyvinyl alcohol, “M” represents JM-17L having a degree of saponification of 96 mol %, and “T” represents JT-05 having a degree of saponification of 94 mol %.

TABLE 2

| | | | | | | remaining amount of volatile active substance | | | | |
|---|---|---|---|---|---|---|---|---|---|---|
| | | | | | | weight ratio relative to the initial amount | | | | |
| | molar | | | | | | | | | the day when |
| | ratio of | glass transition | | | | | | | | remaining |
| | hydrophilic | temperature | | evaporation | | 10 | 20 | 30 | 40 | amount reached |
| | part to | of polymer *2 | viscosity | residue | weather | days | days | days | days | not more than |
| | acetate part | (° C.) | (mPa · s) | (%) | resistance | later *3 | later *3 | later *3 | later *3 | 5% (day) |
| Example 1 | 24.1 | 30 | 60 | 34.1 | High | 66 | 49 | 33 | 24 | 84 |
| Example 2 | 15.7 | −17 | 90 | 43.5 | High | 69 | 51 | 35 | 27 | 89 |
| Example 3 | 24.1 | −47 | 70 | 38.2 | High | 70 | 55 | 38 | 28 | 94 |
| Example 4 | 24.1 | 30 | 60 | 34.1 | High | 68 | 52 | 35 | 26 | 90 |
| Example 5 | 24.1 | 30 | 60 | 34.1 | High | 70 | 56 | 41 | 33 | 104 |
| Example 6 | 24.1 | 30 | 60 | 34.1 | High | 68 | 52 | 36 | 28 | 91 |
| Example 7 | 24.1 | 30 | 60 | 34.1 | High | 71 | 56 | 41 | 31 | 100 |
| Example 8 | 24.1 | 30 | 60 | 34.1 | High | 74 | 61 | 46 | 35 | 116 |
| Example 9 | 24.1 | 30 | 60 | 34.1 | High | 66 | 48 | 32 | 24 | 81 |
| Comp. Ex. 1 | 24.1 | 30 | 40 | 22.0 | Low | 51 | 36 | 23 | 19 | 69 |
| Comp. Ex. 2 | — | 30 | 70 | 51.0 | High | 76 | 73 | 72 | 72 | not measurable |

*2 value obtained by calculation based on equation (1).
*3 weight ratio relative to the initial amount which is regarded as 100.

Table 2 shows the results relating to the sustained release preparation comprising polymer particles obtained by polymerizing the ethylenically unsaturated group-containing monomers (A) and polyvinyl alcohol (C2) having a degree of saponification of more than 91.5 mol % and less than 98 mol % and comprising neither polyvinyl alcohol (C1) having a degree of saponification of more than 82 mol % but not more than 91.5 mol % nor polyvinyl alcohol (C3) having a degree of saponification of not less than 98 mol %.

In Comparative Example 1 for the sustained release preparation comprising polyvinyl alcohol (C2) in an amount of 53% by weight relative to the total amount of the ethylenically unsaturated group-containing monomers (A), weather resistance was inferior, and a half or more thereof was released in the first ten days, preventing uniform release.

### Example 10

The 70 parts by weight of ion-exchanged water was placed in a four-necked glass flask equipped with a stirrer, a reflux condenser and a thermometer, and air displacement with nitrogen was sufficiently performed in the flask. Then stirring was started. The temperature inside the flask was raised to 75° C., and 0.5 parts by weight of sodium persulfate was added thereto as a polymerization initiator.

The 100 parts by weight of vinyl acetate monomers, 30 parts by weight of aqueous 20 wt % solution of PVA (JT-05 produced by Japan VAM & POVAL Co., Ltd., a degree of saponification of 94 mol %, an average polymerization degree of 500), which was 6% by weight relative to the vinyl acetate monomers, and 35 parts by weight of ion-exchanged water were placed and stirred in a homo-mixer for 5 minutes to prepare a emulsion of monomers. After the emulsion was added dropwise into the four-necked flask for 4 hours, the polymerization was further continued for 2 hours. Then, the resulting mixture was reacted at 80° C. for 1 hour and cooled to 30° C. A polyvinyl acetate particle water dispersion having 44.5% by weight of evaporation residue and viscosity of 60 mPa·s was obtained.

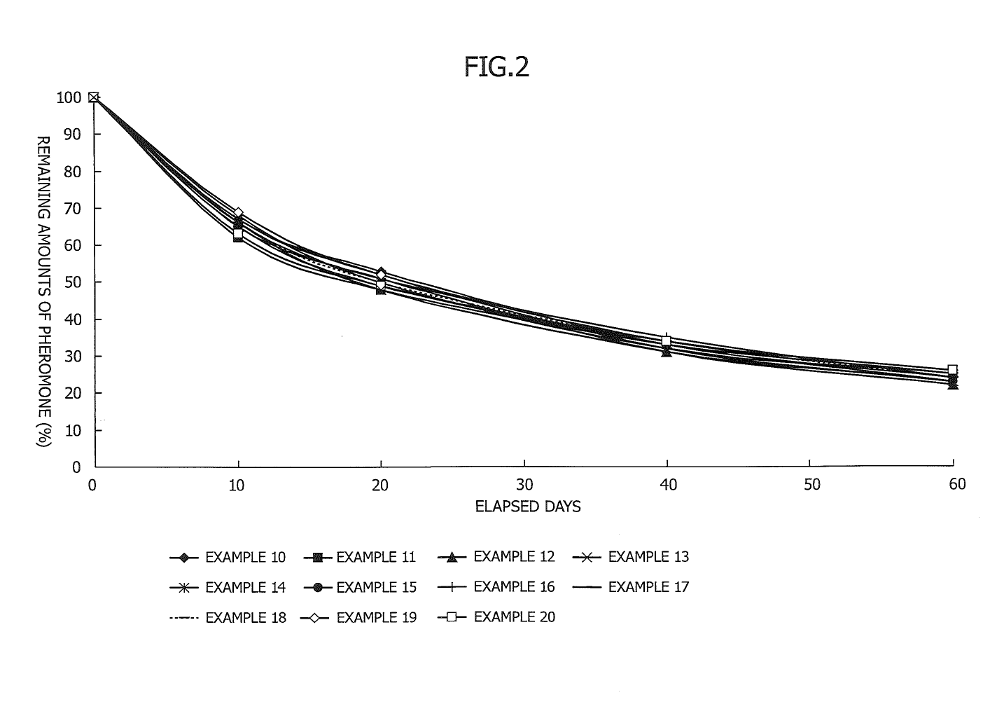

To the water dispersion, 5 parts by weight of Z-8-dodecenyl acetate (product of Shin-Etsu Chemical Co., Ltd., boiling point of 300° C.) as sex pheromone of OFM was added, and the mixture was stirred at 25° C. for 1 hour. Then 40 parts by weight of aqueous 10 wt % solution of PVA (JF-17 produced by Japan VAM & POVAL Co., Ltd., a degree of saponification of 98.5 mol %, an average polymerization degree of 1700), which was 4% by weight relative to the vinyl acetate monomers, was added thereto and stirred at 25° C. for further 30 minutes to obtain a sustained release preparation. The same tests as those in Example 1 were conducted. The composition in each step is shown in Table 3, and the results are shown in Table 4 and FIG. 2.

### Examples 11 to 20

The polymer particle water dispersion and the sustained release preparation were produced based on the polymerization compositions with an addition after the polymerization as shown in Table 3 in the same manner as in Example 1. Then the same tests as those in Example 1 were conducted. The used PVA included JT-05 (product of Japan VAM & POVAL Co., Ltd., a degree of saponification of 94 mol %, an average polymerization degree of 500), JM-17L (product of Japan VAM & POVAL Co., Ltd., a degree of saponification of 96 mol %, an average polymerization degree of 1700), JF-05 (product of Japan VAM & POVAL Co., Ltd., a degree of saponification of 98.5 mol %, an average polymerization degree of 500), and JF-17 (product of Japan VAM & POVAL Co., Ltd., a degree of saponification of 98.5 mol %, an average polymerization degree of 1700). The used sex pheromone included Z-8-dodecenyl acetate (product of Shin-Etsu Chemical Co., Ltd., boiling point of 300° C.) as sex pheromone of OFM, E,E-8,10-dodecadienol (product of Shin-Etsu Chemical Co., Ltd., boiling point of 271° C.) as sex pheromone of CDM, (±)-cis-7,8-epoxy-2-methyloctadecane (product of Shin-Etsu Chemical Co., Ltd., boiling point of 332° C.) as sex pheromone of GM, E-5-dodecenyl acetate (product of Shin-Etsu Chemical Co., Ltd., boiling point of 211° C.) as sex pheromone of PTwB, and ZZ/ZE-7,11-hexadecadienyl acetate (product of Shin-Etsu Chemical Co., Ltd., boiling point of 349° C.) as sex pheromone of PBW. The results are shown in Table 4 and FIG. 2.

TABLE 3

| | | | | | | | | | total |
|---|---|---|---|---|---|---|---|---|---|
| | polymerizatoin step | | | | | after polymerizatoin | | | amount |
| | (part by weight) | | | | | (part by weight) | | | of |
| | monomer | | | polyvinyl | polyvinyl | | | polyvinyl | polyvinyl |
| | vinyl | ethyl | butyl | alcohol | alcohol | | | alcohol | alcohol |
| | acetate | acrylate | acrylate | (C2) *1 | (C3) *1 | pheromone | | (C3) *1 | (part by weight) |
| Example 10 | 100 | — | — | 6(T) | — | OFM | 5 | 4(F17) | 10 |
| Example 11 | 100 | — | — | 13(M) | — | OFM | 5 | 15(F05) | 28 |
| Example 12 | 100 | — | — | 6(T) | — | CDM | 5 | 4(F17) | 10 |
| Example 13 | 100 | — | — | 6(T) | — | GM | 5 | 4(F17) | 10 |
| Example 14 | 100 | — | — | 6(T) | — | PTwB | 5 | 4(F17) | 10 |
| Example 15 | 100 | — | — | 6(T) | — | PBW | 5 | 4(F17) | 10 |
| Example 16 | 50 | — | 50 | 10(T) | — | OFM | 5 | 4(F17) | 14 |
| Example 17 | — | 20 | 80 | 6(T) | — | OFM | 5 | 4(F17) | 10 |
| Example 18 | 100 | — | — | 6(T) | — | OFM | 3.5 | 4(F17) | 10 |
| Example 19 | 100 | — | — | 6(T) | — | OFM | 10 | 4(F17) | 10 |
| Example 20 | 100 | — | — | 5(T) | 15(F17) | OFM | 5 | — | 20 |

*1 As the polyvinyl alcohol, “M” represents JM-17L having a degree of saponification of 96 mol %, and “T” represents JT-05 having a degree of saponification of 94 mol %. “F17” represents JF-17 having a degree of saponification of 98.5 mol %, and “F05” represents JF-05 having a degree of saponificaiton of 98.5 mol %.

TABLE 4

| | | | | | | remaining amount of volatile active substance | | | | |
|---|---|---|---|---|---|---|---|---|---|---|
| | | | | | | weight ratio relative to the initial amount | | | | |
| | molar | | | | | | | | | the day when |
| | ratio of | glass transition | | | | | | | | remaining |
| | hydrophilic | temperature | | evaporation | | 10 | 20 | 30 | 40 | amount reached |
| | part to | of polymer *2 | viscosity | residue | weather | days | days | days | days | not more than |
| | acetate part | (° C.) | (mPa · s) | (%) | resistance | later *3 | later *3 | later *3 | later *3 | 5% (day) |
| Example 10 | 23.1 | 30 | 60 | 40.3 | High | 67 | 53 | 33 | 24 | 84 |
| Example 11 | 36.8 | 30 | 90 | 33.0 | High | 62 | 48 | 33 | 25 | 85 |
| Example 12 | 23.1 | 30 | 60 | 40.3 | High | 65 | 51 | 31 | 22 | 79 |
| Example 13 | 23.1 | 30 | 60 | 40.3 | High | 66 | 48 | 31 | 23 | 78 |
| Example 14 | 23.1 | 30 | 60 | 40.3 | High | 67 | 52 | 32 | 23 | 81 |
| Example 15 | 23.1 | 30 | 60 | 40.3 | High | 65 | 49 | 33 | 23 | 81 |
| Example 16 | 20.4 | −17 | 80 | 40.1 | High | 66 | 51 | 35 | 24 | 86 |
| Example 17 | 23.1 | −47 | 55 | 40.3 | High | 68 | 50 | 32 | 25 | 84 |
| Example 18 | 23.1 | 30 | 60 | 40.3 | High | 66 | 50 | 34 | 24 | 83 |
| Example 19 | 26.0 | 30 | 60 | 40.3 | High | 63 | 47 | 30 | 21 | 77 |
| Example 20 | 37.6 | 30 | 50 | 30.7 | High | 63 | 49 | 34 | 26 | 86 |

*2 value obtained by calculation based on equation (1).
*3 weight ratio relative to the initial amount which is regarded as 100.

Table 4 shows results relating to a sustained release preparation comprising the polymer particles obtained by polymerizing the ethylenically unsaturated group-containing monomers (A), polyvinyl alcohol (C2) having a degree of saponification of more than 91.5 mol % and less than 98 mol %, and polyvinyl alcohol (C3) having a degree of saponification of not less than 98 mol %, and comprising no polyvinyl alcohol (C1) having a degree of saponification of more than 82 mol % but not more than 91.5 mol %.

### Example 21

The 70 parts by weight of ion-exchanged water was placed in a four-necked glass flask equipped with a stirrer, a reflux condenser and a thermometer, and air displacement with nitrogen was sufficiently performed in the flask. Then stirring was started. The temperature inside the flask was raised to 75° C., and 0.5 parts by weight of sodium persulfate was added thereto as a polymerization initiator.

The 100 parts by weight of vinyl acetate monomers, 25 parts by weight of aqueous 20 wt % solution of PVA (JP-05 produced by Japan VAM & POVAL Co., Ltd., a degree of saponification of 88 mol %, an average polymerization degree of 500), which was 5% by weight relative to the vinyl acetate monomers, 60 parts by weight of aqueous 10 wt % solution of PVA (JM-17L produced by Japan VAM & POVAL Co., Ltd., a degree of saponification of 96 mol %, an average polymerization degree of 1700), which was 6% by weight relative to the vinyl acetate monomers, and 30 parts by weight of ion-exchanged water were placed and stirred in a homo-mixer for 5 minutes to prepare a emulsion of monomers. After the emulsion was added dropwise into the four-necked flask for 4 hours, the polymerization was further continued for 2 hours. Then, the resulting mixture was reacted at 80° C. for 1 hour and cooled to 30° C. A polyvinyl acetate particle water dispersion having 38.5% by weight of evaporation residue and viscosity of 60 mPa·s was obtained.

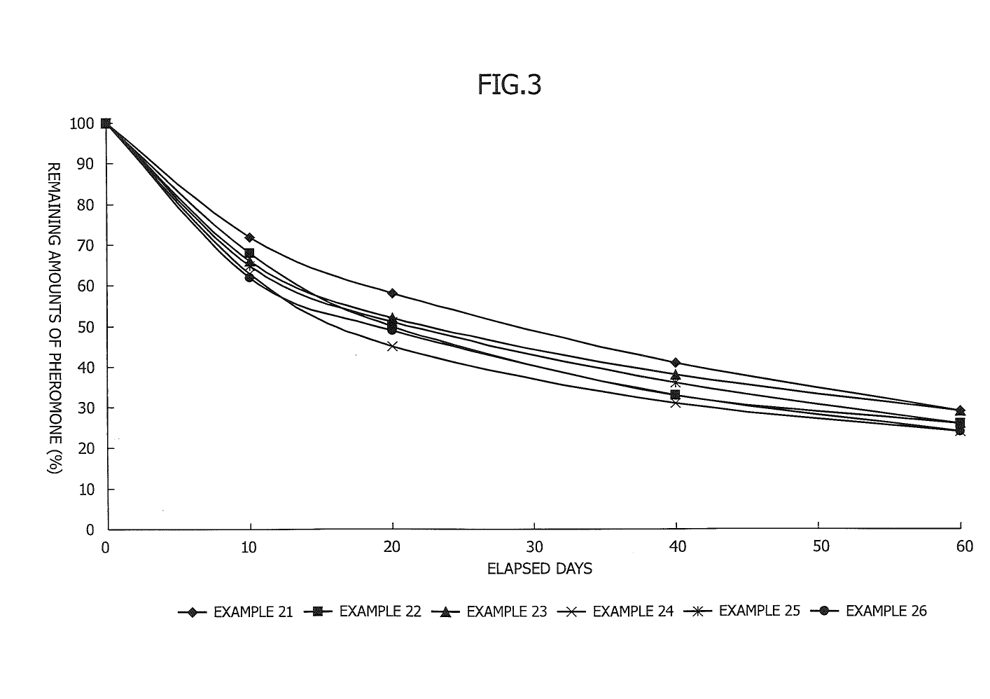

To the water dispersion, 5 parts by weight of Z-8-dodecenyl acetate (product of Shin-Etsu Chemical Co., Ltd., boiling point of 300° C.) as sex pheromone of OFM was added, and the mixture was stirred at 25° C. for 1 hour. Then 70 parts by weight of aqueous 10 wt % solution of PVA (JF-17 produced by Japan VAM & POVAL Co., Ltd., a degree of saponification of 98.5 mol %, an average polymerization degree of 1700), which was 7% by weight relative to the vinyl acetate monomers, was added thereto to obtain a sustained release preparation. The same tests as those in Example 1 were conducted. The composition in each step is shown in Table 5, and the results are shown in Table 6 and FIG. 3.

### Examples 22 to 26

The polymer particle water dispersion and the sustained release preparation were produced based on the polymerization compositions with an addition after the polymerization as shown in Table 5 in the same manner as in Example 1. Then the same tests as those in Example 1 were conducted. The used PVA included JP-05 (product of Japan VAM & POVAL Co., Ltd., a degree of saponification of 88 mol %, an average polymerization degree of 500), PVA-706 (product of Kuraray Co., Ltd., a degree of saponification of 91.5 mol %, an average polymerization degree of 600), JT-05 (product of Japan VAM & POVAL Co., Ltd., a degree of saponification of 94 mol %, an average polymerization degree of 500), JM-17L (product of Japan VAM & POVAL Co., Ltd., a degree of saponification of 96 mol %, an average polymerization degree of 1700), and JF-17 (product of Japan VAM & POVAL Co., Ltd., a degree of saponification of 98.5 mol %, an average polymerization degree of 1700). The used sex pheromone included Z-8-dodecenyl acetate (product of Shin-Etsu Chemical Co., Ltd., boiling point of 300° C.) as sex pheromone of OFM, E,E-8,10-dodecadienol (product of Shin-Etsu Chemical Co., Ltd., boiling point of 271° C.) as sex pheromone of CDM, (±)-cis-7,8-epoxy-2-methyloctadecane (product of Shin-Etsu Chemical Co., Ltd., boiling point of 332° C.) as sex pheromone of GM, E-5-dodecenyl acetate (product of Shin-Etsu Chemical Co., Ltd., boiling point of 211° C.) as sex pheromone of PTwB, and ZZ/ZE-7,11-hexadecadienyl acetate (product of Shin-Etsu Chemical Co., Ltd., boiling point of 349° C.) as sex pheromone of PBW. The results are shown in Table 6 and FIG. 3.

TABLE 5

| | polymerizatoin step | | | | | after polymerization | | |
|---|---|---|---|---|---|---|---|---|
| | (part by weight) | | | | | (part by weight) | | |
| | monomer | | | polyvinyl | polyvinyl | | | polyvinyl |
| | vinyl | ethyl | butyl | alcohol | alcohol | | | alcohol |
| | acetate | acrylate | acrylate | (C1) *1 | (C2) *1 | pheromone | | (C3) *1 |
| Example 21 | 100 | — | — | 5(P) | 6(M) | OFM | 5 | 7(F17) |
| Example 22 | 100 | — | — | 22(A) | 10(M) | OFM | 5 | 13(F17) |
| Example 23 | 100 | — | — | 7(P) | 25(T) | CDM | 5 | 10(F17) |
| Example 24 | 100 | — | — | 10(P) | 10(T) | GM | 5 | 25(F17) |
| Example 25 | 50 | — | 50 | 5(P) | 6(M) | PTwB | 5 | 7(F17) |
| Example 26 | — | 20 | 80 | 5(P) | 6(M) | PBW | 5 | 7(F17) |

*1 As the polyvinyl alcohol, “P” represents JP-05 having a degree of saponification of 88 mol %, and “A” represents PVA-706 having a degree of saponification of 91.5 mol %, “M” represents JM-17L having a degree of saponificaiton of 96 mol %, and “T” represents JT-05 having a degree of saponification of 94 mol %, and “F17” represents JF-17 having a degree of saponification of 98.5 mol %.

TABLE 6

| | | | | | | remaining amount of volatile active substance | | | | |
|---|---|---|---|---|---|---|---|---|---|---|
| | | | | | | weight ratio relative to the initial amount | | | | |
| | molar | | | | | | | | | the day when |
| | ratio of | glass transition | | | | | | | | remaining |
| | hydrophilic | temperature | | evaporation | | 10 | 20 | 30 | 40 | amount reached |
| | part to | of polymer *2 | viscosity | residue | weather | days | days | days | days | not more than |
| | acetate part | (° C.) | (mPa · s) | (%) | resistance | later *3 | later *3 | later *3 | later *3 | 5% (day) |
| Example 21 | 18.7 | 30 | 60 | 38.5 | High | 72 | 58 | 41 | 29 | 100 |
| Example 22 | 17.6 | 30 | 50 | 32.3 | High | 68 | 50 | 33 | 26 | 86 |
| Example 23 | 16.2 | 30 | 65 | 32.7 | High | 66 | 52 | 38 | 29 | 94 |
| Example 24 | 20.4 | 30 | 75 | 39.0 | High | 63 | 45 | 31 | 24 | 79 |
| Example 25 | 18.7 | −17 | 60 | 37.1 | High | 65 | 51 | 36 | 26 | 89 |
| Example 26 | 18.7 | −47 | 65 | 37.1 | High | 62 | 49 | 33 | 24 | 84 |

*2 value obtained by calculation based on equation (1).
*3 weight ratio relative to the initial amount which is regarded as 100.

Table 6 shows the results relating to the sustained release preparation comprising the polymer particles obtained by polymerizing the ethylenically unsaturated group-containing monomers (A), polyvinyl alcohol (C2) having a degree of saponification of more than 91.5 mol % and less than 98 mol %, polyvinyl alcohol (C1) having a degree of saponification of more than 82 mol % but not more than 91.5 mol %, and polyvinyl alcohol (C3) having a degree of saponification of not less than 98 mol %.

### Examples 27 to 87 and Comparative Examples 3 to 6

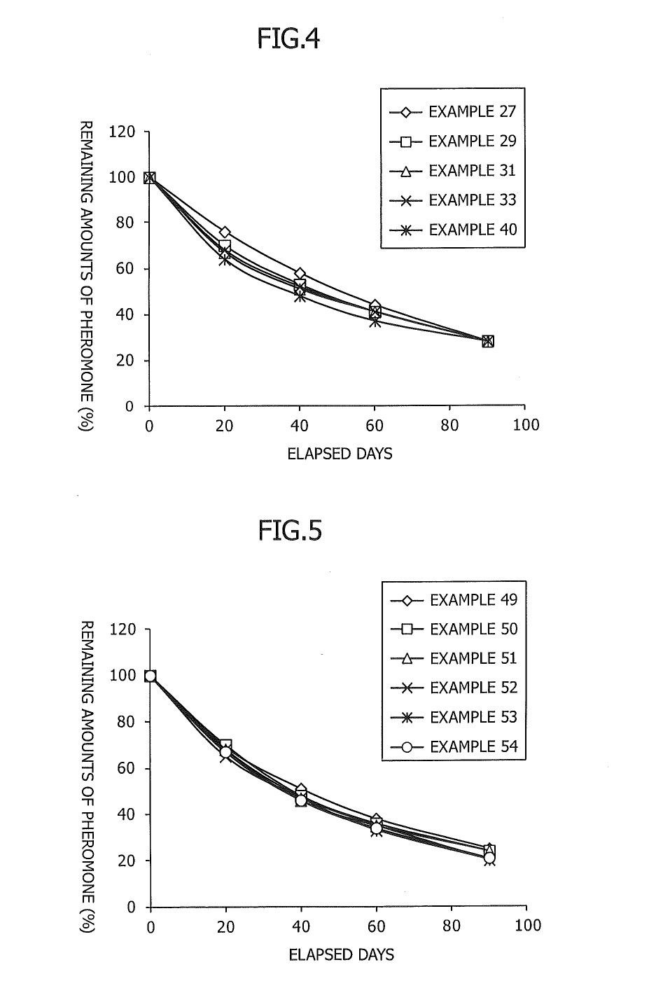

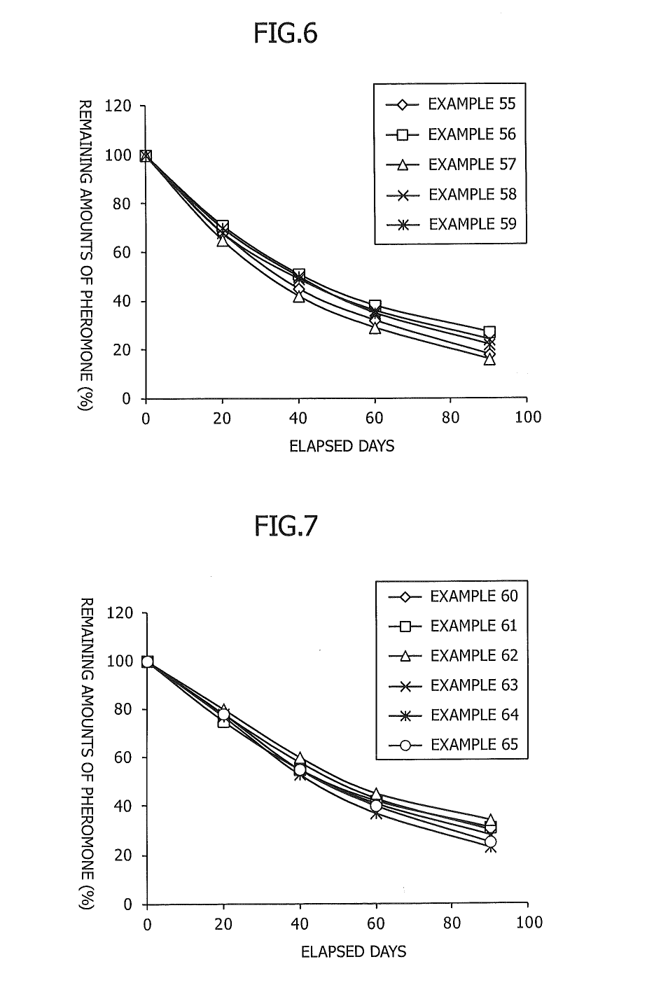

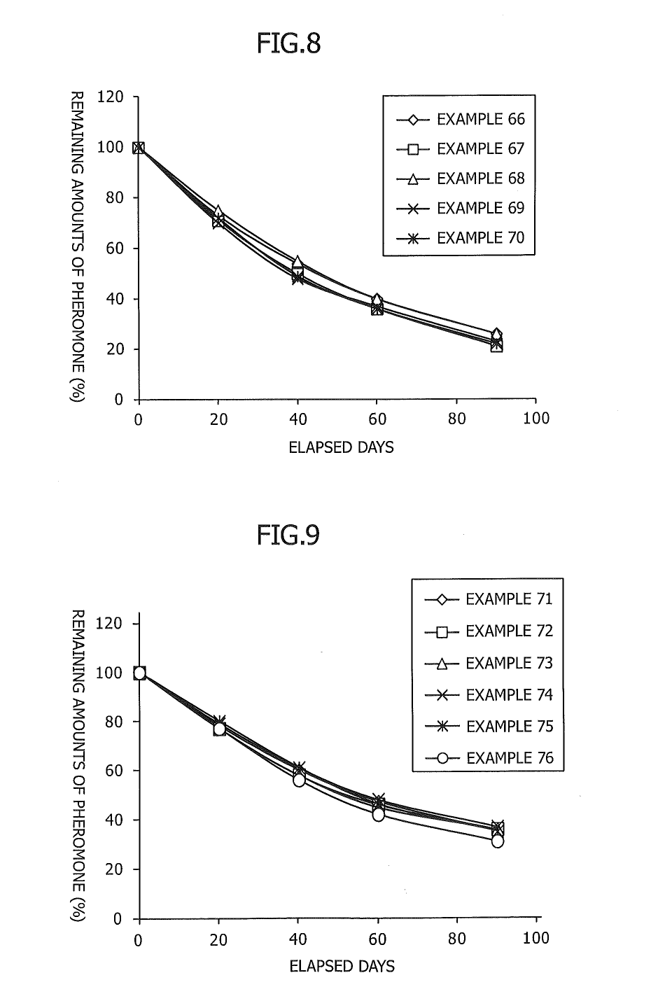

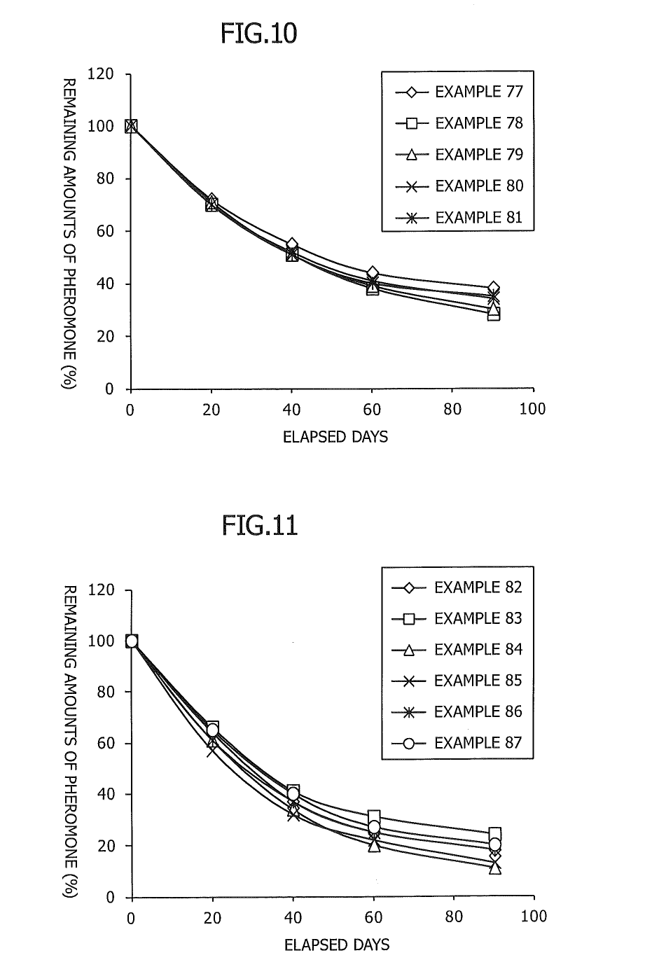

The polymer particle water dispersion and the sustained release preparation were produced based on the polymerization compositions with an addition after the polymerization as shown in Tables 7, 9, 11, 13 and 15 in the same manner as in Example 1. Then the same tests as those in Example 1 were conducted. The volatile active substance other than the sex pheromone included an aromatic such as leaf alcohol (boiling point of 156° C.), limonene (boiling point of 176° C.) and citral (boiling point of 229° C.), and an agricultural chemical such as diazinon (decomposed at 120° C.), and a deodorant such as lauryl methacrylate (boiling point of 305° C.). The results are shown in Tables 8, 10, 12, 14 and 16, and FIGS. 4 to 11.

TABLE 7

| | | | | | | after | |
|---|---|---|---|---|---|---|---|
| | polymerization step | | | | | polymerization | |
| | (part by weight) | | | | | (part by weight) | |
| | monomer | | | | polyvinyl | volatile | |
| | vinyl | butyl | 2-ethylhexyl | acrylic | alcohol | active | |
| | acetate | acrylate | acrylate | acid | (C2) *1 | substance | |
| Example 27 | 80 | 18 | — | 2 | 10(T) | leaf alcohol | 6 |
| Example 28 | 55 | 43 | — | 2 | 15(T) | leaf alcohol | 10 |
| Example 29 | 70 | 28 | — | 2 | 10(T) | limonene | 6 |
| Example 30 | 70 | 28 | — | 2 | 13(T) | limonene | 4 |
| Example 31 | 90 | 8 | — | 2 | 8(T) | citral | 8 |
| Example 32 | 60 | 38 | — | 2 | 10(T) | citral | 16 |
| Example 33 | 70 | — | 28 | 2 | 10(T) | diazinon | 6 |
| Comp. Ex. 3 | 80 | 18 | — | 2 | 53(T) | leaf alcohol | 6 |
| Comp. Ex. 4 | 70 | 28 | — | 2 | 55(T) | limonene | 6 |
| Comp. Ex. 5 | 90 | 8 | — | 2 | 53(T) | citral | 8 |
| Comp. Ex. 6 | 70 | — | 28 | 2 | 56(T) | diazinon | 6 |

*1 As the polyvinyl alcohol, “T” represents JT-05 having a degree of saponification of 94 mol %.

TABLE 8

| | | | | | | remaining amount of volatile active substance | | | | |
|---|---|---|---|---|---|---|---|---|---|---|
| | | | | | | weight ratio relative to the initial amount | | | | |
| | molar | | | | | | | | | the day when |
| | ratio of | glass transition | | | | | | | | remaining |
| | hydrophilic | temperature | | evaporation | | 20 | 40 | 60 | 90 | amount reached |
| | part to | of polymer *2 | viscosity | residue | weather | days | days | days | days | not more than |
| | acetate part | (° C.) | (mPa · s) | (%) | resistance | later *3 | later *3 | later *3 | later *3 | 5% (day) |
| Example 27 | 15.7 | 9 | 70 | 40.7 | — | 76 | 58 | 44 | 28 | 214 |
| Example 28 | 15.7 | 4 | 80 | 38.5 | — | 73 | 54 | 41 | 26 | 200 |
| Example 29 | 15.7 | 0 | 60 | 40.7 | — | 70 | 53 | 41 | 28 | 202 |
| Example 30 | 15.7 | 0 | 75 | 39.6 | — | 73 | 55 | 44 | 28 | 213 |
| Example 31 | 15.7 | 18 | 50 | 41.4 | — | 67 | 51 | 41 | 28 | 199 |
| Example 32 | 15.7 | −10 | 55 | 40.9 | — | 64 | 48 | 38 | 27 | 188 |
| Example 33 | 15.7 | −9 | 60 | 41.4 | High | 68 | 52 | 41 | 28 | 200 |
| Comp. Ex. 3 | 15.7 | 9 | 40 | 30.3 | — | 50 | 33 | 25 | 20 | 167 |
| Comp. Ex. 4 | 15.7 | 0 | 40 | 30.5 | — | 48 | 30 | 22 | 16 | 149 |
| Comp. Ex. 5 | 15.7 | 18 | 35 | 31.5 | — | 46 | 29 | 23 | 18 | 160 |
| Comp. Ex. 6 | 15.7 | −9 | 40 | 31.7 | Low | 49 | 35 | 27 | 19 | 169 |

*2 value obtained by calculation based on equation (1).
*3 weight ratio relative to the initial amount which is regarded as 100.

TABLE 9

| | polymerization step | | | | | | |
|---|---|---|---|---|---|---|---|
| | (part by weight) | | | | | after polymerization | |
| | Monomer | | | polyvinyl | polyvinyl | (part by weight) | |
| | vinyl | butyl | acrylic | alcohol | alcohol | volatile active | |
| | acetate | acrylate | Acid | (C2) *1 | (C3) *1 | substance | |
| Example 34 | 98 | — | 2 | 4(T) | 10(F05) | leaf alcohol | 6 |
| Example 35 | 65 | 33 | 2 | 10(T) | 5(F05) | leaf alcohol | 10 |
| Example 36 | 70 | 28 | 2 | 10(T) | 7(F05) | limonene | 6 |
| Example 37 | 70 | 28 | 2 | 15(T) | 5(F05) | limonene | 10 |
| Example 38 | 70 | 28 | 2 | 10(T) | 5(F05) | citral | 6 |
| Example 39 | 80 | 18 | 2 | 10(T) | 7(F05) | citral | 6 |
| Example 40 | 70 | 28 | 2 | 10(T) | 7(F05) | lauryl methacrylate | 6 |

*1 As the polyvinyl alcohol, “T” represents JT-05 having a degree of saponification of 94 mol %, “F05” represents JF-05 having a degree of saponification of 98.5 mol %.

TABLE 10

| | | | | | remaining amount of volatile active substance | | | | |
|---|---|---|---|---|---|---|---|---|---|
| | | | | | weight ratio relative to the initial amount | | | | |
| | | | | | | | | | the day when |
| | | glass transition | | | | | | | remaining amount |
| | molar ratio of | temperature | | evaporation | 20 | 40 | 60 | 90 | reached |
| | hydrophilic part | of polymer *2 | viscosity | residue | days | days | days | days | not more than 5% |
| | to acetate part | (° C.) | (mPa · s) | (%) | later *3 | later *3 | later *3 | later *3 | (day) |
| Example 34 | 35.4 | 30 | 70 | 39.7 | 68 | 47 | 37 | 27 | 188 |
| Example 35 | 21.3 | −6 | 60 | 40.5 | 67 | 50 | 39 | 27 | 200 |
| Example 36 | 23.4 | 0 | 65 | 39.4 | 68 | 51 | 37 | 25 | 186 |
| Example 37 | 19.7 | 0 | 70 | 39.9 | 65 | 48 | 38 | 27 | 188 |
| Example 38 | 21.4 | 0 | 70 | 39.9 | 70 | 51 | 38 | 27 | 203 |
| Example 39 | 23.4 | 9 | 70 | 39.4 | 67 | 49 | 38 | 29 | 201 |
| Example 40 | 23.4 | 0 | 70 | 39.4 | 64 | 48 | 37 | 28 | 189 |

*2 value obtained by calculation based on equation (1).
*3 weight ratio relative to the initial amount which is regarded as 100.

TABLE 11

| | polymerization step | | | | | | | after polymerization | | |
|---|---|---|---|---|---|---|---|---|---|---|
| | (part by weight) | | | | | | | (part by weight) | | |
| | Monomer | | | | polyvinyl | polyvinyl | polyvinyl | | | polyvinyl |
| | vinyl | butyl | acrylic | | alcohol | alcohol | alcohol | | | alcohol |
| | acetate | acrylate | acid | ethylene | (C1) *1 | (C2) *1 | (C3) *1 | volatile active substance | | (C3) *1 |
| Example 41 | 65 | 33 | 2 | — | 3(P) | 6(T) | 5(F05) | leaf alcohol | 6 | — |
| Example 42 | 80 | — | — | 20 | 8(P) | 3(T) | — | leaf alcohol | 6 | 10(F05) |
| Example 43 | 70 | 28 | 2 | — | 1(P) | 8(T) | 7 (F05) | limonene | 6 | — |
| Example 44 | 75 | — | — | 25 | 7(P) | 4 (T) | — | limonene | 6 | 9(F05) |
| Example 45 | 70 | 28 | 2 | — | 2(P) | 6(T) | 5(F05) | citral | 6 | — |
| Example 46 | 70 | — | — | 30 | 8(P) | 3(T) | — | citral | 6 | 10(F05) |
| Example 47 | 70 | 28 | 2 | — | 4(P) | 3(T) | 7(F05) | lauryl methacrylate | 6 | — |
| Example 48 | 80 | — | — | 20 | 10 (P) | 3(T) | — | lauryl methacrylate | 6 | 12(F05) |

*1 As the polyvinyl alcohol, “P” represents JP-05 having a degree of saponification of 88 mol %, “T” represents JT-05 having a degree of saponification of 94 mol %, and “F05” represents JF-05 having a degree of saponification of 98.5 mol %.

TABLE 12

| | | | | | remaining amount of volatile active substance | | | | |
|---|---|---|---|---|---|---|---|---|---|
| | | | | | weight ratio relative to the initial amount | | | | |
| | | | | | | | | | the day when |
| | | glass transition | | | | | | | remaining amount |
| | molar ratio of | temperature | | evaporation | 20 | 40 | 60 | 90 | reached |
| | hydrophilic part | of polymer *2 | viscosity | residue | days | days | days | days | not more than 5% |
| | to acetate part | (° C.) | (mPa · s) | (%) | later *3 | later *3 | later *3 | later*3 | (day) |
| Example 41 | 17.0 | 10 | 60 | 40.9 | 66 | 48 | 36 | 29 | 200 |
| Example 42 | 15.9 | 7 | 90 | 55.0 | 65 | 46 | 34 | 27 | 188 |
| Example 43 | 18.7 | 4 | 60 | 39.7 | 65 | 48 | 37 | 30 | 200 |
| Example 44 | 16.0 | 7 | 70 | 55.0 | 67 | 49 | 36 | 29 | 202 |
| Example 45 | 18.7 | 0 | 60 | 41.2 | 64 | 48 | 37 | 28 | 186 |
| Example 46 | 15.9 | −19 | 65 | 55.0 | 67 | 51 | 40 | 30 | 213 |
| Example 47 | 17.9 | 28 | 60 | 41.4 | 67 | 49 | 37 | 29 | 198 |
| Example 48 | 15.6 | 7 | 70 | 55.0 | 66 | 47 | 35 | 27 | 188 |

*2 value obtained by calculation based on equation (1).
*3 weight ratio relative to the initial amount which is regarded as 100.

TABLE 13

| | polymerization step | | | | | | | after polymerization | | | | |
|---|---|---|---|---|---|---|---|---|---|---|---|---|
| | (part by weight) | | | | | | | (part by weight) | | | | |
| | Monomer | | | | polyvinyl | polyvinyl | polyvinyl | | | polyvinyl | polyvinyl | polyvinyl |
| | vinyl | butyl | ethyl | acrylic | alcohol | alcohol | alcohol | | | alcohol | alcohol | alcohol |
| | acetate | acrylate | acrylate | acid | (C1) *1 | (C2) *1 | (C3) *1 | volatile active substance | | (C1) *1 | (C2) *1 | (C3) *1 |
| Example 49 | 80 | 18 | — | 2 | — | 10(T) | — | leaf alcohol | 6 | — | — | 5 (F05) |
| Example 50 | 70 | 28 | — | 2 | — | 10(T) | — | limonene | 6 | — | — | 5(F05) |
| Example 51 | 90 | 8 | — | 2 | — | 10(T) | — | citral | 6 | — | — | 5(F05) |
| Example 52 | 70 | — | 28 | 2 | — | 10(T) | — | diazinon | 6 | — | — | 5(F05) |
| Example 53 | 70 | 28 | — | 2 | — | 10(T) | — | lauryl methacrylate | 6 | — | — | 5(F05) |
| Example 54 | 70 | 28 | — | 2 | — | 10(T) | — | lauryl methacrylate | 6 | — | — | — |
| Example 55 | 80 | 18 | — | 2 | — | — | 10(F05) | leaf alcohol | 6 | — | 5(T) | — |
| Example 56 | 70 | 28 | — | 2 | — | — | 10(F05) | limonene | 6 | — | 5(T) | — |
| Example 57 | 90 | 8 | — | 2 | — | — | 10(F05) | citral | 6 | — | 5(T) | — |
| Example 58 | 70 | — | 28 | 2 | — | — | 10(F05) | diazinon | 6 | — | 5(T) | — |
| Example 59 | 70 | 28 | — | 2 | — | — | 10(F05) | lauryl methacrylate | 6 | — | 5(T) | — |
| Example 60 | 80 | 18 | — | 2 | 8(P) | — | — | leaf alcohol | 6 | — | 5(T) | 10(F05) |
| Example 61 | 70 | 28 | — | 2 | 8(P) | — | — | limonene | 6 | — | 5(T) | 10(F05) |
| Example 62 | 90 | 8 | — | 2 | 8(P) | — | — | citral | 6 | — | 5(T) | 10(F05) |
| Example 63 | 70 | — | 28 | 2 | 8(P) | — | — | diazinon | 6 | — | 5(T) | 10(F05) |
| Example 64 | 70 | — | 28 | 2 | — | 5 (T) | 5 (F05) | diazinon | 6 | — | — | — |
| Example 65 | 70 | 28 | — | 2 | 8(P) | — | — | lauryl methacrylate | 6 | — | 5(T) | 10(F05) |
| Example 66 | 80 | 18 | — | 2 | — | 10(T) | — | leaf alcohol | 6 | 5(P) | — | 10(F05) |
| Example 67 | 70 | 28 | — | 2 | — | 10(T) | — | limonene | 6 | 5(P) | — | 10(F05) |
| Example 68 | 90 | 8 | — | 2 | — | 10(T) | — | citral | 6 | 5(P) | — | 10(F05) |
| Example 69 | 70 | — | 28 | 2 | — | 10(T) | — | diazinon | 6 | 5(P) | — | 10(F05) |
| Example 70 | 70 | 28 | — | 2 | — | 10(T) | — | lauryl methacrylate | 6 | 5(P) | — | 10(F05) |

*1 As the polyvinyl alcohol, “P” represents JP-05 having a degree of saponification of 88 mol %, “T” represents JT-05 having a degree of saponification of 94 mol %, and “F05” represents JF-05 having a degree of saponification of 98.5 mol %.

TABLE 14

| | | | | | | remaining amount of volatile active substance | | | | |
|---|---|---|---|---|---|---|---|---|---|---|
| | | | | | | weight ratio relative to the initial amount | | | | |
| | | | | | | | | | | the day when |
| | | glass transition | | | | | | | | remaining amount |
| | molar ratio | temperature | | evaporation | | 20 | 40 | 60 | 90 | reached |
| | of hydrophilic part to | of polymer*2 | viscosity | residue | weather | days | days | days | days | not more than 5% |
| | acetate part | (° C.) | (mPa · s) | (%) | resistance | later*3 | later*3 | later*3 | later*3 | (day) |
| Example 49 | 21.4 | 9 | 65 | 41.0 | — | 69 | 51 | 38 | 25 | 186 |
| Example 50 | 21.4 | 0 | 60 | 40.2 | — | 70 | 48 | 36 | 24 | 183 |
| Example 51 | 21.4 | 18 | 60 | 40.5 | — | 68 | 46 | 35 | 24 | 185 |
| Example 52 | 21.4 | −9 | 70 | 40.8 | High | 65 | 47 | 35 | 20 | 174 |
| Example 53 | 21.4 | 0 | 60 | 40.1 | — | 68 | 47 | 33 | 20 | 175 |
| Example 54 | 15.7 | 0 | 65 | 41.1 | — | 67 | 46 | 34 | 21 | 174 |
| Example 55 | 32.8 | 9 | 70 | 40.6 | — | 68 | 45 | 32 | 18 | 170 |
| Example 56 | 32.8 | 0 | 65 | 40.5 | — | 71 | 51 | 38 | 27 | 192 |
| Example 57 | 32.8 | 18 | 70 | 40.8 | — | 65 | 42 | 29 | 16 | 164 |
| Example 58 | 32.8 | −9 | 75 | 40.1 | High | 68 | 49 | 36 | 24 | 185 |
| Example 59 | 32.8 | 0 | 70 | 40.3 | — | 70 | 50 | 35 | 22 | 176 |
| Example 60 | 15.8 | 9 | 45 | 40.1 | — | 78 | 58 | 43 | 30 | 196 |
| Example 61 | 15.8 | 0 | 50 | 40.0 | — | 75 | 55 | 42 | 31 | 198 |
| Example 62 | 15.8 | 18 | 50 | 39.8 | — | 80 | 60 | 45 | 34 | 222 |
| Example 63 | 15.8 | −9 | 60 | 40.1 | High | 78 | 55 | 41 | 28 | 214 |
| Example 64 | 26.0 | −9 | 70 | 40.5 | High | 77 | 53 | 37 | 23 | 177 |
| Example 65 | 15.8 | 0 | 50 | 39.9 | — | 78 | 55 | 40 | 25 | 189 |
| Example 66 | 18.0 | 9 | 70 | 41.2 | — | 73 | 54 | 40 | 26 | 193 |
| Example 67 | 18.0 | 0 | 70 | 40.6 | — | 71 | 50 | 36 | 21 | 174 |
| Example 68 | 18.0 | 18 | 65 | 40.8 | — | 75 | 55 | 40 | 26 | 191 |
| Example 69 | 18.0 | −9 | 70 | 41.3 | High | 70 | 48 | 37 | 23 | 180 |
| Example 70 | 18.0 | 0 | 65 | 40.2 | — | 72 | 49 | 36 | 22 | 175 |

*2 value obtained by calculation based on equation (1).
*3 weight ratio relative to the initial amount which is regarded as 100.

TABLE 15

| | polymerization step | | | | | | | after polymerization | | | | |
|---|---|---|---|---|---|---|---|---|---|---|---|---|
| | (part by weight) | | | | | | | (part by weight) | | | | |
| | Monomer | | | | polyvinyl | polyvinyl | polyvinyl | | | polyvinyl | polyvinyl | polyvinyl |
| | vinyl | butyl | ethyl | acrylic | alcohol | alcohol | alcohol | | | alcohol | alcohol | alcohol |
| | acetate | acrylate | acrylate | acid | (C1) *1 | (C2) *1 | (C3) *1 | volatile active substance | | (C1) *1 | (C2) *1 | (C3) *1 |
| Example 71 | 80 | 18 | — | 2 | — | — | 10(F05) | leaf alcohol | 6 | 5(P) | 5(T) | — |
| Example 72 | 70 | 28 | — | 2 | — | — | 10(F05) | limonene | 6 | 5(P) | 5(T) | — |
| Example 73 | 90 | 8 | — | 2 | — | — | 10(F05) | citral | 6 | 5(P) | 5(T) | — |
| Example 74 | 70 | — | 28 | 2 | — | — | 10(F05) | diazinon | 6 | 5(P) | 5(T) | — |
| Example 75 | 70 | — | 28 | 2 | 5(P) | 5(T) | — | diazinon | 6 | — | — | 10(F05) |
| Example 76 | 70 | 28 | — | 2 | — | — | 10(F05) | lauryl methacrylate | 6 | 5(P) | 5(T) | — |
| Example 77 | 80 | 18 | — | 2 | — | 8(T) | 7(F05) | leaf alcohol | 6 | 5(P) | — | — |
| Example 78 | 70 | 28 | — | 2 | — | 8(T) | 7(F05) | limonene | 6 | 5(P) | — | — |
| Example 79 | 90 | 8 | — | 2 | — | 8(T) | 7(F05) | citral | 6 | 5(P) | — | — |
| Example 80 | 70 | — | 28 | 2 | — | 8(T) | 7(F05) | diazinon | 6 | 5(P) | — | — |
| Example 81 | 70 | 28 | — | 2 | — | 8(T) | 7(F05) | lauryl methacrylate | 6 | 5(P) | — | — |
| Example 82 | 80 | 18 | — | 2 | 2(P) | — | 10(F05) | leaf alcohol | 6 | — | 5(T) | — |
| Example 83 | 70 | 28 | — | 2 | 2(P) | — | 10(F05) | limonene | 6 | — | 5(T) | — |
| Example 84 | 90 | 8 | — | 2 | 2(P) | — | 10(F05) | citral | 6 | — | 5(T) | — |
| Example 85 | 70 | — | 28 | 2 | 2(P) | — | 10(F05) | diazinon | 6 | — | 5(T) | — |
| Example 86 | 70 | — | 28 | 2 | 2(P) | 5(T) | 10(F05) | diazinon | 6 | — | — | — |
| Example 87 | 70 | 28 | — | 2 | 2(P) | — | 10(F05) | lauryl methacrylate | 6 | — | 5(T) | — |

*1 As the polyvinyl alcohol, “P” represents JP-05 having a degree of saponification of 88 mol %, “T” represents JT-05 having a degree of saponification of 94 mol %, and “F05” represents JF-05 having a degree of saponification of 98.5 mol %.

TABLE 16

| | | | | | | remaining amount of volatile active substance | | | | |
|---|---|---|---|---|---|---|---|---|---|---|
| | | | | | | weight ratio relative to the initial amount | | | | |
| | | | | | | | | | | the day when |
| | | glass transition | | | | | | | | remaining amount |
| | molar ratio | temperature | | evaporation | | 20 | 40 | 60 | 90 | reached |
| | of hydrophilic part to | of polymer *2 | viscosity | residue | weather | days | days | days | days | not more than 5% |
| | acetate part | (° C.) | (mPa · s) | (%) | resistance | later *3 | later *3 | later *3 | later *3 | (day) |
| Example 71 | 18.7 | 9 | 70 | 40.2 | — | 78 | 60 | 47 | 35 | 224 |
| Example 72 | 18.7 | 0 | 75 | 40.6 | — | 77 | 58 | 46 | 36 | 226 |
| Example 73 | 18.7 | 18 | 70 | 40.2 | — | 77 | 58 | 45 | 36 | 227 |
| Example 74 | 18.7 | −9 | 70 | 40.0 | High | 79 | 61 | 48 | 37 | 229 |
| Example 75 | 18.7 | −9 | 55 | 40.3 | High | 80 | 61 | 46 | 35 | 222 |
| Example 76 | 18.7 | 0 | 75 | 40.6 | — | 77 | 56 | 42 | 31 | 219 |
| Example 77 | 16.3 | 9 | 50 | 40.5 | — | 72 | 55 | 44 | 38 | 234 |
| Example 78 | 16.3 | 0 | 45 | 40.1 | — | 70 | 51 | 38 | 28 | 232 |
| Example 79 | 16.3 | 18 | 50 | 41.1 | — | 71 | 51 | 39 | 30 | 213 |
| Example 80 | 16.3 | −9 | 50 | 40.6 | High | 70 | 52 | 41 | 34 | 238 |
| Example 81 | 16.3 | 0 | 45 | 40.2 | — | 70 | 51 | 40 | 35 | 239 |
| Example 82 | 24.3 | 9 | 65 | 40.3 | — | 64 | 37 | 25 | 18 | 167 |
| Example 83 | 24.3 | 0 | 65 | 40.2 | — | 66 | 41 | 31 | 24 | 188 |
| Example 84 | 24.3 | 18 | 60 | 40.0 | — | 61 | 34 | 20 | 11 | 144 |
| Example 85 | 24.3 | −9 | 65 | 39.8 | High | 57 | 32 | 22 | 13 | 150 |
| Example 86 | 24.3 | −9 | 70 | 40.3 | High | 61 | 37 | 25 | 18 | 155 |
| Example 87 | 24.3 | 0 | 60 | 40.1 | — | 65 | 40 | 27 | 20 | 159 |

*2 value obtained by calculation based on equation (1).
*3 weight ratio relative to the initial amount which is regarded as 100.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A sustained release preparation comprising:
a water dispersion having viscosity at 25° C. of not more than 100 mPa·s and comprising
polymer particles which are obtained by polymerizing ethylenically unsaturated group-containing monomers (A),
polyvinyl alcohol (C2) in an amount of more than 0% by weight but not more than 50% by weight relative to a total amount of the ethylenically unsaturated group-containing monomers (A), having a degree of saponification of more than 91.5 mol % and less than 98 mol %, and water, and
a volatile active substance which is selected from a group consisting of a pheromone substance, an agricultural chemical, an aromatic, a deodorant and an antibacterial agent.

2. The sustained release preparation according to claim 1, further comprising:
polyvinyl alcohol (C3) in an amount of more than 0% by weight and less than 50% by weight relative to the total amount of the ethylenically unsaturated group-containing monomers (A), having a degree of saponification of not less than 98 mol %, wherein a total amount of the polyvinyl alcohols (C2) and (C3) is not more than 50% by weight relative to the total amount of the ethylenically unsaturated group-containing monomers (A).

3. The sustained release preparation according to claim 2, further comprising:
polyvinyl alcohol (C1) in an amount of more than 0% by weight and less than 50% by weight relative to the total amount of the ethylenically unsaturated group-containing monomers (A), having a degree of saponification of more than 82 mol % but not more than 91.5 mol %,
wherein a total amount of the polyvinyl alcohols (C1), (C2) and (C3) is not more than 50% by weight relative to the total amount of the ethylenically unsaturated group-containing monomers (A).

4. The sustained release preparation according to claim 1, wherein a ratio of a molar amount of hydrophilic part to a molar amount of acetate part is not more than 40.0, the former being a total molar weight of vinyl alcohol monomer units and the latter being a total molar weight of vinyl acetate monomer units in a total amount of the polyvinyl alcohol.

5. The sustained release preparation according to claim 1, wherein the volatile active substance in an amount of from 3% by weight to 20% by weight relative to the ethylenically unsaturated group-containing monomers (A) comprised by the water dispersion.

6. The sustained release preparation according to claim 1, wherein the volatile active substance is selected from a group consisting of acetate, alcohol (including phenol), epoxide, alkane, alkene, aldehyde, ketone, carboxylic acid, ester and ether, each having a boiling point of from 100° C. to 350° C. and having six to twenty carbon atoms.

7. A method for producing a sustained release preparation comprising:
a polymerization step of emulsion-polymerizing ethylenically unsaturated group-containing monomers (A) in the presence of polyvinyl alcohol to obtain a polymer particle water dispersion having viscosity at 25° C. of not more than 100 mPa·s,
wherein the polyvinyl alcohol is selected from a group consisting of polyvinyl alcohol (C2) having a degree of saponification of more than 91.5 mol % and less than 98 mol %, a combination of the polyvinyl alcohol (C2) and polyvinyl alcohol (C3) having a degree of saponification of not less than 98 mol %, and a combination of the polyvinyl alcohols (C2) and (C3) and polyvinyl alcohol (C1) having a degree of saponification of more than 82 mol % but not more than 91.5 mol %; and
when the polyvinyl alcohol is the polyvinyl alcohol (C2) in absence of the polyvinyl alcohols (C1) and (C3), the polyvinyl alcohol (C2) in an amount of more than 0% by weight but not more than 50% by weight relative to a total amount of the ethylenically unsaturated group-containing monomers (A) is present during the polymerization;
when the polyvinyl alcohol is the combination of the polyvinyl alcohols (C2) and (C3) in absence of the polyvinyl alcohol (C1), all of the polyvinyl alcohols (2) and (3) are present during the polymerization, or one of the polyvinyl alcohols (C2) and (C3) is present during polymerization and the other of the polyvinyl alcohols (C2) and (C3) is blended after the polymerization, so that a total amount of the polyvinyl alcohols (2) and (3) is more than 0% by weight but not more than 50% by weight relative to the total amount of the ethylenically unsaturated group-containing monomers (A); and
when the polyvinyl alcohol is the combination of the polyvinyl alcohols (C2), (C3) and (C1), all of the polyvinyl alcohols (C2), (C3) and (C1) are present during the polymerization, or one or two types of the polyvinyl alcohols (C2), (C3) and (C1) are present during the polymerization and the other type or types of the polyvinyl alcohols (C2), (C3) and (C1), which are not present during the polymerization, are blended after the polymerization, so that a total amount of the polyvinyl alcohols (C2), (C3) and (C1) is more than 0% by weight but not more than 50% by weight relative to the total amount of the ethylenically unsaturated group-containing monomers (A); and
a mixing step of mixing the polymer particle water dispersion with a volatile active substance selected from a group consisting of a pheromone substance, an agricultural chemical, an aromatic, a deodorant and antibacterial agent.

8. The method for producing a sustained release preparation according to claim 7, wherein the polyvinyl alcohol is the polyvinyl alcohol (C2) in absence of the polyvinyl alcohols (C3) and (C1), and is present during the polymerization in an amount of more than 0% by weight but not more than 50% by weight relative to the total amount of the ethylenically unsaturated group-containing monomers (A).

9. The method for producing a sustained release preparation according to claim 7, wherein the polyvinyl alcohol is the combination of the polyvinyl alcohols (C2) and (C3) in absence of the polyvinyl alcohol (C1), and all of the polyvinyl alcohols (C2) and (C3) are present during the polymerization, or the polyvinyl alcohol (C2) is present during the polymerization and the polyvinyl alcohol (C3) is blended after the polymerization, or the polyvinyl alcohol (C3) is present during the polymerization and the polyvinyl alcohol (C2) is blended after the polymerization, so that the total amount of the polyvinyl alcohol (C2) and (C3) is more than 0% by weight but not more than 50% by weight relative to the total amount of the ethylenically unsaturated group-containing monomers (A).

10. The method for producing a sustained release preparation according to claim 7, wherein the polyvinyl alcohol is the combination of the polyvinyl alcohol (C1), (C2) and (C3), and all of the polyvinyl alcohols (C1), (C2), and (C3) is present during the polymerization, or the polyvinyl alcohol (C1) is present during the polymerization and the polyvinyl alcohols (C2) and (C3) are blended after the polymerization, or the polyvinyl alcohol (C2) is present during the polymerization and the polyvinyl alcohols (C1) and (C3) are blended after the polymerization, or the polyvinyl alcohol (C3) is present during the polymerization and the polyvinyl alcohols (C1) and (C2) are blended after the polymerization, or the polyvinyl alcohols (C1) and (C2) are present during the polymerization and the polyvinyl alcohol (C3) is blended after the polymerization, or the polyvinyl alcohols (C1) and (C3) are present during the polymerization and the polyvinyl alcohol (C2) is blended after the polymerization, or the polyvinyl alcohols (C2) and (C3) are present during the polymerization and the polyvinyl alcohol (C1) is blended after the polymerization, so that a total amount of the polyvinyl alcohol (C1), (C2), and (C3) is more than 0% by weight but not more than 50% by weight relative to the total amount of the ethylenically unsaturated group-containing monomers (A).
